(19) United States
(12) Patent Application Publication
(10) Pub. No.: US 2024/0356991 A1
(43) Pub. Date: Oct. 24, 2024

(54) METHOD AND APPARATUS FOR SESSION MANAGEMENT

(71) Applicant: Telefonaktiebolaget LM Ericsson (publ), Stockholm (SE)

(72) Inventors: Yongdi GU, Shanghai (CN); Yunjie LU, Shanghai (CN); Juying GAN, Shanghai (CN); Wen ZHANG, Shanghai (CN)

(21) Appl. No.: 18/684,270

(22) PCT Filed: Aug. 12, 2022
(86) PCT No.: PCT/CN2022/112102

§ 371 Date: Feb. 16, 2024

(30) Foreign Application Priority Data
Aug. 20, 2021 (WO) PCT/CN2021/113915
Oct. 29, 2021 (WO) PCT/CN2021/127501

(51) Int. Cl. H04L 65/1069; H04W 76/20

(52) U.S. Cl. CPC H04L 65/1069; H04W 76/20

(57) ABSTRACT

Embodiments of the present disclosure provide method and apparatus for session management. A method performed by a first session management function (SMF) includes sending to a second SMF a first request including a state of a user plane connection or an indication. The state or the indication indicates whether there is an ongoing procedure during which the first SMF is not able to handle update request from the second SMF. The method further includes receiving a first response from the second SMF.

### TECHNICAL FIELD

The non-limiting and exemplary embodiments of the present disclosure generally relate to the technical field of communications, and specifically to methods and apparatuses for session management.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example NR (new radio) as defined by 3rd Generation Partnership Project (3GPP), a PDU (protocol data unit) session may be established between a UE (user equipment) and a DN (Data Network). The PDU session may be served by several network devices or functions. For example, the PDU session may be served by AN (access network), UPF (user plane function), I-UPF (Intermediate UPF or I_UPF), AMF (access and mobility function), SMF (session management function), I-SMF (Intermediate SMF or I_SMF), etc. The I-SMF is an SMF that is inserted to support a PDU session as the UE is located in an area which cannot be controlled by an original SMF because the UPF(s) belong to a different SMF service area.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

I-SMF may be selected by AMF if a service area of the selected SMF cannot control UPF that can serve a UE location.

According to 3GPP TS 23.501 V17.0.0, the disclosure of which is incorporated by reference herein in its entirety, when the UE is outside of the SMF service area, or current SMF cannot serve the target DNAI (DN (data network) Access Identifier) for the traffic routing towards Local DN, an I-SMF is inserted between the SMF and the AMF. The I-SMF has an N11 interface with the AMF. The I-SMF has an N16a interface with the SMF. The I-SMF is responsible of controlling the UPF(s) that the SMF cannot directly control. The exchange of the SM (session management) context and forwarding of tunnel information if needed are done between two SMFs directly without involvement of AMF.

Depending on scenario, a PDU session in non-roaming case or local breakout is either served by a single SMF or served by an SMF and an I-SMF. When a PDU session is served by both an SMF and an I-SMF, the SMF is the NF (network function) instance that has the interfaces towards the PCF and CHF (Charging Function).

During mobility events such as Hand-Over or AMF change, if the service area of the SMF does not include the new UE location, then the AMF selects and inserts an I-SMF which can serve the new UE location and S-NSSAI (Single Network Slice Selection Assistance Information).

According to 3GPP TS 23.502 V17.0.0, the disclosure of which is incorporated by reference herein in its entirety, the I-SMF is inserted, changed or removed during a service request procedure. When an AMF receives a service request message, for each PDU session to be activated based on the service area information of SMF and the location where the UE camped, the AMF determines which service request procedure is used.

According to 3GPP TS 29.512 V17.3.0, the disclosure of which is incorporated by reference herein in its entirety, if the “SAREA_CH” is provisioned, when the NF service consumer detects a change of serving area (i.e. tracking area, or if the feature “2G3GIWK” is supported routing area), the NF service consumer shall include the “SAREA_CH” within the “repPolicyCtrlReqTriggers” attribute and the current TAI (Tracking Area Identity) within the “userLocationInfo” attribute in either the “eutraLocation” or “nrLocation”, or the current Routing Area within the “userLocationInfo” attribute in the “utraLocation” attribute when UTRAN (Universal Terrestrial Radio Access Network) access, or in the “geraLocation” attribute when GERAN (GSM EDGE (Enhanced Data rates for GSM Evolution) Radio Access Network) access, as applicable.

If the “SCNN_CH” is provisioned, when the NF (network function) service consumer detects a change of serving Network Function (i.e. the AMF, ePDG (evolved Packet Data Gateway), S-GW (Serving Gateway) or if the feature “2G3GIWK” is supported SGSN (Serving GPRS (General Packet Radio Service)), the NF service consumer shall include the “SCNN_CH” within the “repPolicyCtrlReqTriggers” attribute and the current serving Network Function in the “servNfId” attribute if available.

A service request procedure may be used by a UE in CM (Connection Management)-IDLE state. The service request procedure may be also used both when the UE is in CM-IDLE and in CM-CONNECTED to activate a user plane connection for an established PDU session.

For example, the UE in CM (Connection Management)-IDLE state may initiate a service request procedure in order to send uplink signaling messages, user data, to request emergency services fallback, or as a response to a network paging request. After receiving the service request message, the AMF may perform authentication. After the establishment of the signaling connection to an AMF, the UE or network may send signaling messages, e.g. PDU session establishment from UE to the SMF, via the AMF. The service request procedure may be used by a UE in CM-CONNECTED to request activation of a user plane connection for PDU sessions and to respond to a NAS (Non-Access Stratum) Notification message from the AMF. When a user plane connection for a PDU session is activated, the AS (Access Stratum) layer in the UE indicates it to the NAS layer.

FIG. 1 shows a flowchart of UE Triggered Service Request procedure according to an embodiment of the present disclosure. FIG. 1 is same as FIG. 4.2.3.2-1 of 3GPP TS 23.502 V17.0.0. The steps of FIG. 1 have been described in clause 4.2.3.2 of 3GPP TS 23.502 V17.0.0, the disclosure of which is incorporated by reference herein in its entirety.

At step 16. [Optional] SMF to PCF (Policy Control Function): If dynamic PCC (Policy and Charging Control) is deployed, SMF may initiate notification about new location information to the PCF (if subscribed) by performing an SMF initiated SM Policy Modification procedure as defined in clause 4.16.5.1 of 3GPP TS 23.502 V17.0.0. The PCF may provide updated policies.

Clause 4.23.4.2 of 3GPP TS 23.502 V17.0.0 describes UE Triggered Service Request without I-SMF change/removal as following. When both I-SMF and SMF are available for a PDU session and no I-SMF change or removal is needed during the service request procedure, the procedure in the clause 4.23.4.2 is used. Compared to the procedure in clause 4.2.3.2 of 3GPP TS 23.502 V17.0.0, the SMF is replaced with the I-SMF and the impacted UPF(s) are UPFs that are controlled by I-SMF. Differences are captured below:
Steps 6a-6b of FIG. 1, these steps are not needed as the CN Tunnel Info of UPF (PSA) allocated for N9 is available at the I-SMF when the I-SMF is inserted.
Step 7a of FIG. 1, the SMF provides the DL Tunnel Info of new intermediate UPF received from I-SMF to UPF (PSA).
Step 10 of FIG. 1, this step does not apply as in this scenario the I-UPF is always needed.
Step 16 of FIG. 1, the SMF gets the UE location information (ULI) from I-SMF at step 5a. If dynamic PCC is deployed, the SMF may notify the UE location information to PCF and gets the updated policy.
Steps 18a-18b of FIG. 1, these steps do not apply as in this scenario the I-UPF is always needed.
Step 21a of FIG. 1, this step does not apply as in this scenario the I-UPF is always needed.

FIG. 2a shows a flowchart of UE Triggered Service Request with I-SMF insertion/change/removal according to an embodiment of the present disclosure. FIG. 2 is same as FIG. 4.23.4.3 of 3GPP TS 23.502 V17.0.0. The steps of FIG. 2 have been described in clause 4.23.4.3 of 3GPP TS 23.502 V17.0.0, the disclosure of which is incorporated by reference herein in its entirety.

FIG. 2b shows a flowchart of Evolved Packet System (EPS) to Fifth Generation System (5GS) mobility for single-registration mode with N26 interface according to an embodiment of the present disclosure. FIG. 2b is same as FIG. 4.11.1.3.3-1 of 3GPP TS 23.502 V17.0.0. The steps of FIG. 2b have been described in clause 4.11.1.3.3 of 3GPP TS 23.502 V17.0.0, the disclosure of which is incorporated by reference herein in its entirety. As described in clause 4.11.1.3.3 of 3GPP TS 23.502 V17.0.0, in the home-routed roaming case and idle state mobility, the AMF selects a default V-SMF (visited SMF) per PDU Session and invokes Nsmf_PDUSession_CreateSMContext service operation of the V-SMF to create an association with the AMF. It includes UE EPS PDN (Packet Data Network) Connection, H-SMF (home SMF) ID (identifier), S-NSSAI and indicates all the PDU Session(s) to be re-activated as received in the Registration request message along with List of one or more PDU sessions To Be Activated.

There are some problems with the existing service request procedures. Currently the state of user plane connection or a new indication indicating whether there's ongoing procedure is not exchanged between two SMFs (such as I-SMF and SMF). SMF doesn't know whether there's ongoing procedure during which I-SMF is not able to handle messages from A-SMF (anchor AMF). Therefore some messages exchanged between two SMFs may not be processed correctly if SMF doesn't know whether another SMF has ongoing procedure which prevents it to handle update request message. Some messages from SMF may not be processed correctly by I-SMF if SMF doesn't know the UP connection state or whether there's ongoing procedure in I-SMF. For example, a problem may happen during Inter/Intra AMF idle mode mobility with UP (user plane) connection activation and I-SMF insertion/change. Without I-SMF involved or with I-SMF removal, SMF initiates notification about new UE location information and/or UE time zone and/or serving Network Function to PCF (if subscribed) by performing an SMF initiated SM Policy Modification procedure during idle mode mobility. PCF may provide updated policies, and then SMF enforces the new policies after the mobility is finished. However with I-SMF insertion or change, I-SMF transfers the UE location information and/or UE time zone and/or serving network function to SMF after it receives such information from AMF during idle mode mobility. SMF may invoke an SMF initiated SM Policy Modification procedure and then PCF may provide updated policies to SMF. A race condition may happen since SMF doesn't know when I-SMF has finished the ongoing UP connection activating procedure and the message comprising the updated policies may be ignored by a busy I-SMF.

Another problem may happen during UE Triggered Service Request without I-SMF change/removal. According to clause 4.23.4.2 of 3GPP TS 23.502 V17.0.0, at step 16 of FIG. 1, the SMF gets the UE location information from I-SMF at step 5a of FIG. 1. If dynamic PCC is deployed, the SMF may notify the UE location information to PCF and gets the updated policy. However SMF will notify the UE location information to PCF immediately in step 5a of FIG. 1 when it receives the UE location information instead of waiting up until step 16 of FIG. 1. SMF may invoke an SMF initiated SM Policy Modification procedure and then PCF may provide updated policies. The race condition may happen since SMF doesn't know when I-SMF finishes the ongoing UP connection activating procedure and the message comprising the updated policies may be ignored by the busy I-SMF.

Another problem may happen during EPS to 5GS Idle mobility using N26 interface with List of one or more PDU sessions To Be Activated. According to 3GPP TS 29.502 V17.1.0, the disclosure of which is incorporated by reference herein in its entirety, I-SMF (V-SMF) knows the pduSessionsActivateList, SMF (H-SMF) doesn't know it. A-SMF (H-SMF) knows current pduSessionId, but I-SMF doesn't know at first and only gets the pduSessionId from SMF (H-SMF) in PduSessionCreatedData. A-SMF (H-SMF) should get the new policy or QoS (Quality of Service) rule from PCF and triggers PDU Session Modification procedure to I-SMF, but I-SMF is busy with UP active procedure and the message comprising the updated policies may be ignored by the busy I-SMF.

To overcome or mitigate at least one of above mentioned problems or other problems, the embodiments of the present disclosure propose an improved solution for session management.

In an embodiment, I-SMF may provide a new indication flag or existing IE (information element) of upCnxState (as described in 3GPP TS 29.502 V17.1.0, the disclosure of which is incorporated by reference herein in its entirety) to SMF in the message of either Nsmf_PDUSession_Create Request or Nsmf_PDUSession_Update Request to show whether the ongoing UP connection activation procedure or other procedures which prevents I-SMF to handle update request from SMF is finished so that based on which SMF could initiate another procedure, e.g., invoking the Nsmf_PDUSession_Update Request service operation towards I-SMF to enforce new policies.

In an embodiment, I-SMF only transfers some necessary information, e.g., anType, ismfPduSessionUri and icnTunnel Info (as described in 3GPP TS 29.502 V17.1.0), to SMF during Nsmf_PDUSession_Create or Nsmf_PDUSession_Update Request and keeps other information, e.g., UE location information (ULI) and/or UE Time Zone and/or serving network function identifier, which may lead SMF to notify PCF about the updated information and following policy update procedure may happen. I-SMF will transfer UE location information (ULI) and/or UE Time Zone and/or serving network function identifier after it finishes the UP activation, i.e., the N3 tunnel establishment and downlink data is OK.

In an embodiment, I-SMF responds VsmfUpdateError (as described in 3GPP TS 29.502 V17.1.0) to SMF including a ProblemDetails structure with “Response codes” set to 409 (Conflict) when it receives Nsmf_PDUSession_Update Request from SMF while UP connection activating or other procedures which prevents I-SMF to handle update request from SMF is ongoing. Then SMF starts timer and keeps retry after it receives the response with the status code of 409.

In an embodiment, I-SMF (V-SMF) sends the List of one or more PDU sessions To Be Activated (called pduSessionActiveList herein) to A-SMF (H-SMF) if I-SMF receives pduSessionActiveList from AMF. A-SMF (H-SMF) can decide when to trigger PCF interaction according to the pduSessionActiveList. For example, the PCF interaction may be triggered by I-SMF (V-SMF) sends information indicating that a PDU session corresponding to a PDU Session ID in the pduSessionActiveList is activated. If I-SMF (V-SMF) finds that the pduSessionId received from the I-SMF (V-SMF) is in the pduSessionActiveList, I-SMF (V-SMF) sends the information indicating that the PDU session corresponding to the PDU Session ID is activated to A-SMF (H-SMF) after the PDU session corresponding to the PDU session identifier is activated.

In a first aspect of the disclosure, there is provided a method performed by a first session management function (SMF). The method comprises sending to a second SMF a first request comprising a state of a user plane connection or an indication. The state or the indication indicates whether there is an ongoing procedure during which the first SMF is not able to handle update request from the second SMF. The method further comprises receiving a first response from the second SMF.

In an embodiment, the state of the user plane connection comprises at least one of ACTIVATED, DEACTIVATED, ACTIVATING, SUSPENDED, or a list of one more protocol data unit (PDU) sessions to be activated.

In an embodiment, when the state of the user plane connection sent in the first request is ACTIVATED or DEACTIVATED or SUSPENDED or when the indication indicates there is not an ongoing procedure during which the first SMF is not able to handle update request from the second SMF, the method further comprises receiving a second request for enforcing at least one updated policy or releasing a protocol data unit (PDU) session from the second SMF after receiving the first response from the second SMF.

In an embodiment, when the state of the user plane connection sent in the first request is ACTIVATING or when the indication indicates there is an ongoing procedure during which the first SMF is not able to handle update request from the second SMF, after receiving the first response from the second SMF and when a timer of the second SMF expires, the method further comprises receiving a second request for enforcing at least one updated policy or releasing a protocol data unit (PDU) session from the second SMF.

In an embodiment, when the first response comprises a PDU session identifier and the state of the user plane connection sent in the first request is the list of one or more PDU sessions to be activated, the method further comprises checking if the PDU session identifier is included in the list of one or more PDU sessions to be activated. The method further comprises sending information indicating that a PDU session corresponding to the PDU session identifier is activated to the second SMF when the PDU session identifier is included in the list of one or more PDU sessions to be activated and after the PDU session corresponding to the PDU session identifier is activated. The method further comprises receiving a second request for enforcing at least one updated policy or releasing a PDU session from the second SMF.

In an embodiment, the second request is a protocol data unit (PDU) session update request.

In an embodiment, the second request comprises at least one updated policy or PDU session release information.

In an embodiment, the first request is a PDU session update request and the first response is a PDU session update response.

In an embodiment, the first request is a PDU session create request and the first response is a PDU session create response.

In an embodiment, the first request further comprises information on policy control request trigger condition.

In an embodiment, the information on policy control request trigger condition comprises at least one of user equipment (UE) location information, a UE time zone, or a serving network function identifier.

In an embodiment, the first request is sent and the first response is received during a procedure of UE triggered service request with intermediate SMF (I-SMF) insertion or change, a procedure of UE triggered service request without I-SMF change or removal, inter access and mobility function (AMF) idle mobility with user plane (UP) connection activation with intermediate SMF (I-SMF) insertion or change, or intra AMF idle mobility with UP connection activation with intermediate SMF (I-SMF) insertion or change, or Evolved Packet System (EPS) to Fifth Generation System (5GS) Idle mode mobility using N26 interface.

In an embodiment, the first SMF is an I-SMF and the second SMF is an SMF.

In an embodiment, the first SMF is a visited SMF and the second SMF is a home SMF.

In an embodiment, the first SMF is an I-SMF and the second SMF is a Packet Data Network Gateway control plane (PGW-C) combined with SMF.

In a second aspect of the disclosure, there is provided a method performed a second SMF. The method comprises receiving a first request comprising a state of a user plane connection or an indication from a first SMF. The state or the indication indicates whether there is an ongoing procedure during which the first SMF is not able to handle update request from the second SMF. The method further comprises sending a first response to the first SMF.

In an embodiment, when the state of the user plane connection received in the first request is ACTIVATED or DEACTIVATED or SUSPENDED or when the indication indicates there is not an ongoing procedure during which the first SMF is not able to handle update request from the second SMF, the method further comprises sending a second request for enforcing at least one updated policy or releasing a protocol data unit (PDU) session to the first SMF after sending the first response to the first SMF.

In an embodiment, when the state of the user plane connection received in the first request is ACTIVATING or when the indication indicates there is an ongoing procedure during which the first SMF is not able to handle update request from the second SMF, the method further comprises sending a second request for enforcing at least one updated policy or releasing a protocol data unit (PDU) session to the first SMF after sending the first response to the first SMF and when a timer of the second SMF expires.

In an embodiment, when the state of the user plane connection received in the first request comprising a list of one or more PDU sessions to be activated and the first response comprises a PDU session identifier, the method further comprises checking if the PDU session identifier is included in the list of one or more PDU sessions to be activated. The method further comprises, when the PDU session identifier is included in the list of one or more PDU sessions to be activated, pausing sending a request for getting at least one updated policy to a policy control function. The method further comprises receiving information indicating that a PDU session corresponding to the PDU session identifier is activated from the first SMF. The method further comprises after receiving the information indicating that the PDU session corresponding to the PDU session identifier is activated from the first SMF, starting to send the request for getting the at least one updated policy to the policy control function. The method further comprises sending a second request for enforcing the at least one updated policy or releasing a PDU session to the first SMF.

In a third aspect of the disclosure, there is provided a method performed a first session management function (SMF). The method comprises sending a third request to a second SMF based on a state of a user plane connection or whether there is an ongoing procedure during which the first SMF is not able to handle update request from the second SMF. The method further comprises receiving a third response from the second SMF.

In an embodiment, when the state of the user plane connection is ACTIVATED or DEACTIVATED or SUSPENDED or when there is not an ongoing procedure during which the first SMF is not able to handle update request from the second SMF, the third request comprises information on policy control request trigger condition.

In an embodiment, when the state of the user plane connection is ACTIVATING or when there is an ongoing procedure during which the first SMF is not able to handle update request from the second SMF, information on policy control request trigger condition is omitted in the third request.

In an embodiment, the method further comprises receiving a fourth request for enforcing at least one updated policy or releasing a protocol data unit (PDU) session from the second SMF after receiving the third response from the second SMF.

In an embodiment, the fourth request is a protocol data unit (PDU) session update request.

In an embodiment, the fourth request comprises at least one updated policy or PDU session release information.

In an embodiment, the third request is a PDU session update request and the third response is a PDU session update response

In an embodiment, the third request is a PDU session create request and the third response is a PDU session create response.

In an embodiment, the third request is sent and the third response is received during a procedure of UE triggered service request with intermediate SMF (I-SMF) insertion or change, a procedure of UE triggered service request without I-SMF change or removal, inter access and mobility function (AMF) idle mobility with user plane (UP) connection activation with intermediate SMF (I-SMF) insertion or change, or intra AMF idle mobility with UP connection activation with intermediate SMF (I-SMF) insertion or change.

In a fourth aspect of the disclosure, there is provided a method performed a second SMF. The method comprises receiving a third request from a first SMF. The third request is sent to the second SMF based on a state of a user plane connection or whether there is an ongoing procedure during which the first SMF is not able to handle update request from the second SMF. The method further comprises sending a third response to the first SMF.

In an embodiment, the method further comprises sending a fourth request for enforcing at least one updated policy or releasing a protocol data unit (PDU) session to the first SMF after sending the third response to the first SMF.

In a fifth aspect of the disclosure, there is provided a method performed a first session management function (SMF). The method comprises receiving a request for enforcing at least one updated policy or releasing a protocol data unit (PDU) session from a second SMF. The method further comprises sending a response comprising a response code set to 409 Conflict to the second SMF when a state of the user plane connection is ACTIVATING or when there is an ongoing procedure during which the first SMF is not able to handle update request from the second SMF.

In an embodiment, the request is a PDU session update request and the response is a PDU session update response.

In an embodiment, the request is received and the response is sent during a procedure of UE triggered service request with intermediate SMF (I-SMF) insertion or change, a procedure of UE triggered service request without I-SMF change or removal, inter access and mobility function (AMF) idle mobility with user plane (UP) connection activation with intermediate SMF (I-SMF) insertion or change, or intra AMF idle mobility with UP connection activation with intermediate SMF (I-SMF) insertion or change.

In a sixth aspect of the disclosure, there is provided a method performed a second SMF. The method comprises sending a request for enforcing at least one updated policy or releasing a protocol data unit (PDU) session to a first SMF. The method further comprises receiving a response comprising a response code set to 409 Conflict from the first SMF when a state of the user plane connection is ACTIVATING or when there is an ongoing procedure during which the first SMF is not able to handle update request from the second SMF. The method further comprises resending the request for enforcing at least one updated policy or releasing a protocol data unit (PDU) session to the first SMF after a time period.

In a seventh aspect of the disclosure, there is provided a first session management function (SMF). The first SMF comprises a processor and a memory coupled to the processor. Said memory contains instructions executable by said processor. Said first SMF is operative to send to a second SMF a first request comprising a state of a user plane connection or an indication. The state or the indication indicates whether there is an ongoing procedure during which the first SMF is not able to handle update request from the second SMF. Said first SMF is further operative to receive a first response from the second SMF.

In an eighth sixth aspect of the disclosure, there is provided a second session management function (SMF). The second SMF comprises a processor and a memory coupled to the processor. Said memory contains instructions executable by said processor. Said second SMF is operative to receive a first request comprising a state of a user plane connection or an indication from the first SMF. The state or the indication indicates whether there is an ongoing procedure during which the first SMF is not able to handle update request from the second SMF. Said second SMF is further operative to send a first response to the first SMF.

In a ninth aspect of the disclosure, there is provided a first session management function (SMF). The first SMF comprises a processor and a memory coupled to the processor. Said memory contains instructions executable by said processor. Said first SMF is operative to send a third request to a second SMF based on a state of a user plane connection or whether there is an ongoing procedure during which the first SMF is not able to handle update request from the second SMF. Said first SMF is further operative to receive a third response from the second SMF.

In a tenth sixth aspect of the disclosure, there is provided a second session management function (SMF). The second SMF comprises a processor and a memory coupled to the processor. Said memory contains instructions executable by said processor. Said second SMF is operative to receive a third request from a first SMF. The third request is sent to the second SMF based on a state of a user plane connection or whether there is an ongoing procedure during which the first SMF is not able to handle update request from the second SMF. Said second SMF is further operative to send a third response to the first SMF.

In an eleventh seventh aspect of the disclosure, there is provided a first session management function (SMF). The first SMF comprises a processor and a memory coupled to the processor. Said memory contains instructions executable by said processor. Said first SMF is operative to receive a request for enforcing at least one updated policy or releasing a protocol data unit (PDU) session from a second SMF. Said first SMF is further operative to send a response comprising a response code set to 409 Conflict to the second SMF when a state of the user plane connection is ACTIVATING or when there is an ongoing procedure during which the first SMF is not able to handle update request from the second SMF.

In a twelfth aspect of the disclosure, there is provided a second session management function (SMF). The second SMF comprises a processor and a memory coupled to the processor. Said memory contains instructions executable by said processor. Said second SMF is operative to send a request for enforcing at least one updated policy or releasing a protocol data unit (PDU) session to a first SMF. Said second SMF is further operative to receive a response comprising a response code set to 409 Conflict from the first SMF when a state of the user plane connection is ACTIVATING or when there is an ongoing procedure during which the first SMF is not able to handle update request from the second SMF. Said second SMF is further operative to resend the request for enforcing at least one updated policy or releasing a protocol data unit (PDU) session to the first SMF after a time period.

In a thirteenth aspect of the disclosure, there is provided a first session management function. The first SMF comprises a first sending module configured to send to a second SMF a first request comprising a state of a user plane connection or an indication. The state or the indication indicates whether there is an ongoing procedure during which the first SMF is not able to handle update request from the second SMF. The first SMF further comprises a first receiving module configured to receive a first response from the second SMF.

In an embodiment, the first SMF further comprises a second receiving module configured to receive a second request for enforcing at least one updated policy or releasing a protocol data unit (PDU) session from the second SMF after receiving the first response from the second SMF, when the state of the user plane connection sent in the first request is ACTIVATED or DEACTIVATED or SUSPENDED or when there is an ongoing procedure during which the first SMF is not able to handle update request from the second SMF.

In an embodiment, the first SMF further comprises a third receiving module configured to, when the state of the user plane connection sent in the first request is ACTIVATING or when the indication indicates there is an ongoing procedure during which the first SMF is not able to handle update request from the second SMF, receive a second request for enforcing at least one updated policy or releasing a protocol data unit (PDU) session from the second SMF after receiving the first response from the second SMF and when a timer of the second SMF expires.

In an embodiment, the first response comprises a PDU session identifier and the state of the user plane connection sent in the first request is the list of one or more PDU sessions to be activated. The first SMF further comprises a checking module configured to check if the PDU session identifier is included in the list of one or more PDU sessions to be activated. The first SMF further comprises a second sending module configured to send information indicating that a PDU session corresponding to the PDU session identifier is activated to the second SMF when the PDU session identifier is included in the list of one or more PDU sessions to be activated and after the PDU session corresponding to the PDU session identifier is activated. The first SMF further comprises a fourth receiving module configured to receive a second request for enforcing at least one updated policy or releasing a PDU session from the second SMF.

In a fourteenth aspect of the disclosure, there is provided a second session management function. The second SMF comprises a receiving module configured to receive a first request comprising a state of a user plane connection or an indication from the first SMF. The state or the indication indicates whether there is an ongoing procedure during which the first SMF is not able to handle update request from the second SMF. The second SMF further comprises a first sending module configured to send a first response to the first SMF.

In an embodiment, the second SMF further comprises a second sending module configured to send a second request for enforcing at least one updated policy or releasing a protocol data unit (PDU) session to the first SMF after sending the first response to the first SMF when the state of the user plane connection received in the first request is ACTIVATED or DEACTIVATED or SUSPENDED or when the indication indicates there is not an ongoing procedure during which the first SMF is not able to handle update request from the second SMF.

In an embodiment, the second SMF further comprises a third sending module configured to send a second request for enforcing at least one updated policy or releasing a protocol data unit (PDU) session to the first SMF after sending the first response to the first SMF and when a timer of the second SMF expires, when the state of the user plane connection received in the first request is ACTIVATING or when the indication indicates there is an ongoing procedure during which the first SMF is not able to handle update request from the second SMF.

In an embodiment, the state of the user plane connection received in the first request comprises a list of one or more PDU sessions to be activated and the first response comprises a PDU session identifier. The second SMF further comprises a checking module configured to check if the PDU session identifier is included in the list of one or more PDU sessions to be activated. The second SMF further comprises a pausing module configured to, when the PDU session identifier is included in the list of one or more PDU sessions to be activated, pause sending a request for getting at least one updated policy to a policy control function. The second SMF further comprises a second receiving module configured to receive information indicating that a PDU session corresponding to the PDU session identifier is activated from the first SMF. The second SMF further comprises a starting module configured to, after receiving the information indicating that the PDU session corresponding to the PDU session identifier is activated from the first SMF, start to send the request for getting the at least one updated policy to the policy control function. The second SMF further comprises a fourth sending module configured to sending a second request for enforcing the at least one updated policy or releasing a PDU session to the first SMF.

In a fifteenth aspect of the disclosure, there is provided a first session management function. The first SMF comprises a sending module configured to send a third request to a second SMF based on a state of a user plane connection or whether there is an ongoing procedure during which the first SMF is not able to handle update request from the second SMF. The first SMF further comprises a first receiving module configured to receive a third response from the second SMF.

In an embodiment, the first SMF further comprises a second receiving module configured to receive a fourth request for enforcing at least one updated policy or releasing a protocol data unit (PDU) session from the second SMF after receiving the third response from the second SMF.

In a sixteenth aspect of the disclosure, there is provided a second session management function. The second SMF comprises a receiving module configured to receive a third request from a first SMF. The third request is sent to the second SMF based on a state of a user plane connection or whether there is an ongoing procedure during which the first SMF is not able to handle update request from the second SMF. The second SMF further comprises a first sending module configured to send a third response to the first SMF.

In an embodiment, the second SMF further comprises a second sending module configured to send a fourth request for enforcing at least one updated policy or releasing a protocol data unit (PDU) session to the first SMF after sending the third response to the first SMF.

In a seventeenth aspect of the disclosure, there is provided a first session management function. The first SMF comprises a receiving module configured to receive a request for enforcing at least one updated policy or releasing a protocol data unit (PDU) session from a second SMF. The first SMF further comprises a sending module configured to send a response comprising a response code set to 409 Conflict to the second SMF when a state of the user plane connection is ACTIVATING or when there is an ongoing procedure during which the first SMF is not able to handle update request from the second SMF.

In an eighteenth aspect of the disclosure, there is provided a second session management function. The second SMF comprises a sending module configured to send a request for enforcing at least one updated policy or releasing a protocol data unit (PDU) session to a first SMF. The second SMF further comprises a receiving module configured to receive a response comprising a response code set to 409 Conflict from the first SMF when a state of the user plane connection is ACTIVATING or when there is an ongoing procedure during which the first SMF is not able to handle update request from the second SMF. The second SMF further comprises a resending module configured to resend the request for enforcing at least one updated policy or releasing a protocol data unit (PDU) session to the first SMF after a time period.

In nineteenth aspect of the disclosure, there is provided a computer program product comprising instructions which when executed by at least one processor, cause the at least one processor to perform the method according to any one of the first, second, third, fourth, fifth or sixth aspects.

In a twentieth aspect of the disclosure, there is provided a computer-readable storage medium storing instructions which when executed by at least one processor, cause the at least one processor to perform the method according to any one of the first, second, third, fourth, fifth or sixth aspects.

Embodiments herein may provide many advantages, of which a non-exhaustive list of examples follows. In some embodiments herein, the race condition is solved between A-SMF (anchor SMF) and I-SMF during inter/intra AMF idle mode mobility with UP connection activation during I-SMF insertion or change or during a procedure of UE triggered service request without I-SMF change or removal or during a procedure of UE triggered service request with intermediate SMF (I-SMF) insertion or change, which will make the procedure less complex and more reliable. In some embodiments herein, SMF could keep the action aligned between UE triggered service request procedure with I-SMF insertion or change and UE triggered service request procedure without I-SMF insertion or change. In some embodiments herein, the statement of “Step 16, the SMF gets the UE location information from I-SMF at step 5a. If dynamic PCC is deployed, the SMF may notify the UE location information to PCF and gets the updated policy” in clause 4.23.4.2 of 3GPP TS 23.502 V17.0.0 could be achieved and implemented. In some embodiments herein, the race condition is solved between A-SMF (H-SMF) and I-SMF (V-SMF) during EPS to 5GS Idle mobility using N26 interface with List of one or more PDU sessions To Be Activated. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a flowchart of UE Triggered Service Request procedure according to an embodiment of the present disclosure;

FIG. 2a shows a flowchart of UE Triggered Service Request with I-SMF insertion/change/removal according to an embodiment of the present disclosure;

FIG. 2b shows a flowchart of EPS to 5GS mobility for single-registration mode with N26 interface according to an embodiment of the present disclosure;

FIG. 3a schematically shows a high level architecture in the fifth generation network according to an embodiment of the present disclosure;

FIG. 3b schematically shows roaming architecture with home-routed traffic for interworking between 5GS and EPC/E-UTRAN according to an embodiment of the present disclosure;

FIG. 4 shows a flowchart of a method according to an embodiment of the present disclosure;

FIG. 5a shows a flowchart of a method according to another embodiment of the present disclosure;

FIG. 5b shows a flowchart of a method according to another embodiment of the present disclosure;

FIG. 6 shows a flowchart of a method according to another embodiment of the present disclosure;

FIG. 7a shows a flowchart of a method according to another embodiment of the present disclosure;

FIG. 7b shows a flowchart of a method according to another embodiment of the present disclosure;

FIG. 8 shows a flowchart of a method according to another embodiment of the present disclosure;

FIG. 9 shows a flowchart of a method according to another embodiment of the present disclosure;

FIG. 10a shows a flowchart of a method according to another embodiment of the present disclosure;

FIG. 10b shows a flowchart of a method according to another embodiment of the present disclosure;

FIG. 10c shows a flowchart of a method according to another embodiment of the present disclosure;

FIG. 10d shows a flowchart of a method according to another embodiment of the present disclosure;

FIG. 11 shows a flowchart of inter AMF idle mode mobility with UP connection activating and I-SMF insertion according to another embodiment of the present disclosure;

FIG. 12 shows a flowchart of inter AMF idle mode mobility with UP connection activating and I-SMF insertion according to an embodiment of the present disclosure;

FIG. 13a shows a flowchart of inter AMF idle mode mobility with UP connection activating and I-SMF insertion according to another embodiment of the present disclosure;

FIG. 13b shows a flowchart of EPS to 5GS Idle mobility using N26 interface with List of one or more PDU sessions To Be Activated according to another embodiment of the present disclosure;

FIG. 14 is a block diagram showing an apparatus suitable for practicing some embodiments of the disclosure;

FIG. 15 is a block diagram showing a first session management function according to an embodiment of the disclosure;

FIG. 16 is a block diagram showing a second session management function according to an embodiment of the disclosure;

FIG. 17 is a block diagram showing a first session management function according to an embodiment of the disclosure;

FIG. 18 is a block diagram showing a second session management function according to an embodiment of the disclosure;

FIG. 19 is a block diagram showing a first session management function according to an embodiment of the disclosure; and

FIG. 20 is a block diagram showing a second session management function according to an embodiment of the disclosure.

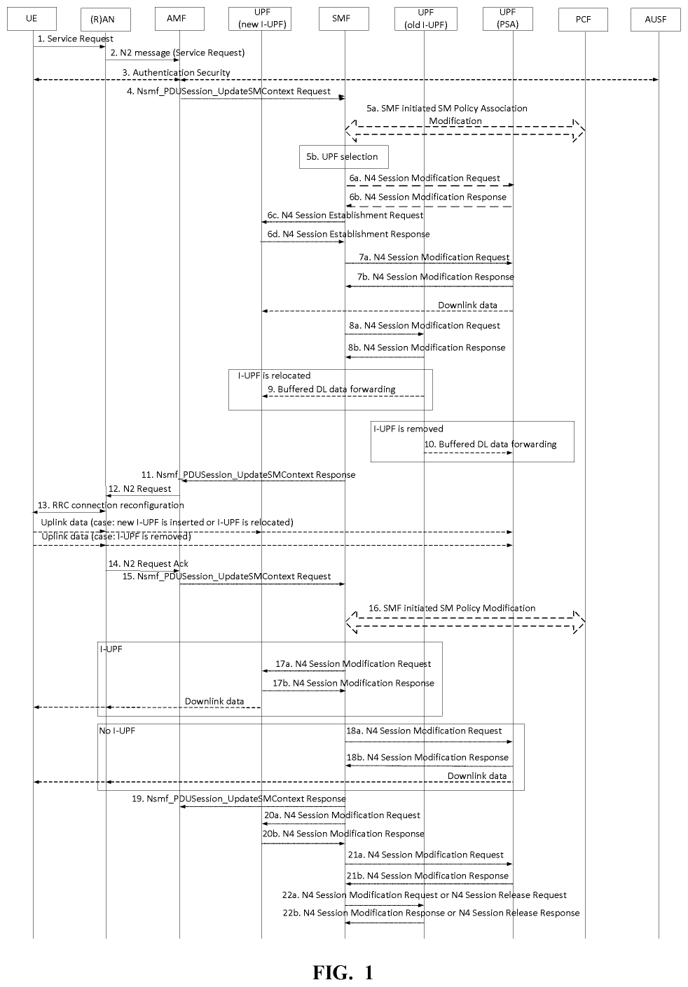

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C or PGW_C), Serving gateway (SGW), SGW control plane (SGW-C or SGW_C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

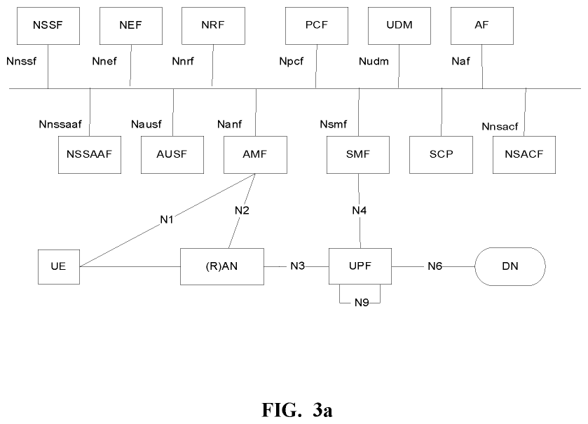

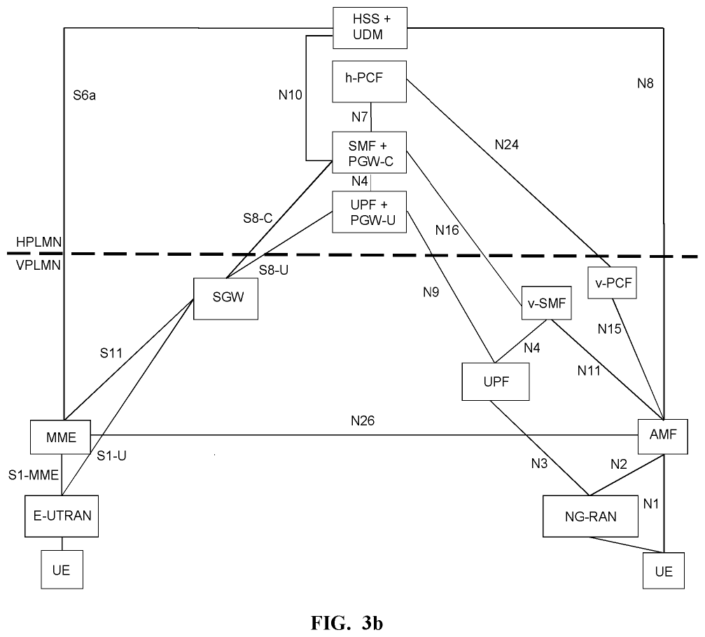

Although the subject matter described herein may be implemented in any appropriate type of system using any suitable components, the embodiments disclosed herein are described in relation to a communication system complied with the exemplary system architectures illustrated in FIG. 3a-3b. For simplicity, the system architectures of FIG. 3a-3b only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

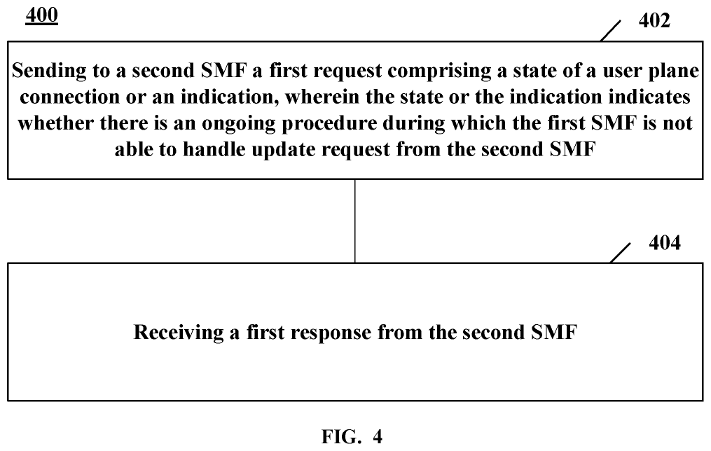

FIG. 3a schematically shows a high level architecture in the fifth generation network according to an embodiment of the present disclosure. For example, the fifth generation network may be 5GS. The architecture of FIG. 3a is same as FIG. 4.2.3-1 as described in 3GPP TS 23.501 V17.0.0, the disclosure of which is incorporated by reference herein in its entirety. The system architecture of FIG. 3a may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 3a. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 3a, the exemplary system architecture also contains the service-based interfaces such as Nnrf, Nnef, Nausf, Nudm, Npcf, Namf, Nnsacf and Nsmf exhibited by NFs such as the NRF, the NEF, the AUSF, the UDM, the PCF, the AMF, the NSACF and the SMF. In addition, FIG. 3a also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 3a may be responsible for functions such as session management, mobility management, authentication, security, etc. The AUSF, AMF, DN, NEF, NRF, NSSF, PCF, SMF, UDM, UPF, AF, UE, (R)AN, SCP, NSACF may include the functionality for example as defined in clause 6.2 of 3GPP TS 23.501 V17.0.0.

FIG. 3b schematically shows roaming architecture with home-routed traffic for interworking between 5GS and EPC (Evolved Packet Core)/E-UTRAN (Evolved Universal Terrestrial Radio Access Network) according to an embodiment of the present disclosure. The architecture of FIG. 3b is same as FIG. 4.3.2-2 as described in 3GPP TS 23.501 V17.2.0. N26 interface is an inter-CN interface between the MME and 5GS AMF in order to enable interworking between EPC and the NG core. Support of N26 interface in the network is optional for interworking. N26 supports subset of the functionalities (essential for interworking) that are supported over S10. PGW-C+SMF and UPF+PGW-U are dedicated for interworking between 5GS and EPC, which are optional and are based on UE MM (Mobility Management) Core Network Capability and UE subscription. UEs that are not subject to 5GS and EPC interworking may be served by entities not dedicated for interworking, i.e. by either by PGW or SMF/UPF. There can be another UPF (not shown in FIG. 3b) between the NG-RAN (next generation radio access network) and the UPF+PGW-U, i.e. the UPF+PGW-U can support N9 towards an additional UPF, if needed.

FIG. 4 shows a flowchart of a method according to an embodiment of the present disclosure, which may be performed by an apparatus implemented in or at or as a first session management function (SMF) or communicatively coupled to the first SMF. As such, the apparatus may provide means or modules for accomplishing various parts of the method 400 as well as means or modules for accomplishing other processes in conjunction with other components. The first SMF may be any suitable network device or node or entity or function which can provide session management function.

At block 402, the first SMF may send to a second SMF a first request comprising a state of a user plane connection or an indication. The state or the indication indicates whether there is an ongoing procedure during which the first SMF is not able to handle update request from the second SMF. The update request may be a PDU session update request such as Nsmf_PDUSession_Update request as described in 3GPP TS 23.502 V17.0.0. The user plane connection may be a PDN (Packet Data Network) connection or a PDU session or other suitable user plane connection. The state of the user plane connection may comprise any suitable state. In an embodiment, the state of the user plane connection may indicate an ongoing user plane connection activation procedure is finished or activating.

The first SMF may send to the second SMF the state of the user plane connection or said information due to various reasons. For example, the second SMF may request the first SMF to send the state of the user plane connection or said information. When the first SMF may need send a PDU session create/update request to the second SMF, the first SMF may send the PDU session create/update request comprising the state of the user plane connection or said information to the second SMF. When the state of the user plane connection has changed, the first SMF may send the state of the user plane connection or said information to the second SMF.

In an embodiment, the state of the user plane connection comprises at least one of ACTIVATED, DEACTIVATED, ACTIVATING, SUSPENDED, or a list of protocol data unit (PDU) sessions to be activated. For example, in 5GS, “ACTIVATED” means that a N3 tunnel is established between the 5G-AN and UPF, i.e., the ongoing user plane connection activation procedure is finished. “DEACTIVATED” means that No N3 tunnel is established between the 5G-AN and UPF. “ACTIVATING” means that a N3 tunnel is being established (the 5G-AN's F-TEID (Fully Qualified TEID (Tunnel Endpoint Identifier)) for downlink traffic is not assigned yet). “SUSPENDED” means that A N3 tunnel is suspended between the 5G-AN and UPF. In an embodiment, the list of one or more PDU sessions to be activated may be same as the List of PDU sessions To Be Activated as described in 3GPP TS 23.502 V17.0.0.

In an embodiment, the first SMF is an I-SMF. The second SMF is an SMF or anchor SMF (A-SMF). In another embodiment, the first SMF is a visited SMF. The second SMF is a home SMF. In still another embodiment, the first SMF is an I-SMF and the second SMF is a Packet Data Network Gateway control plane (PGW-C) combined with SMF.

The first request may be any suitable message which can be sent from the first SMF to the second SMF. In an embodiment, the first request may be a protocol data unit (PDU) session update request. For example, the first request may be Nsmf_PDUSession_Update request as described in 3GPP TS 23.502 V17.0.0 except that it further comprises the state of the user plane connection. In an embodiment, the first request may be a protocol data unit (PDU) session create request. For example, the first request may be Nsmf_PDUSession_Create request as described in 3GPP TS 23.502 V17.0.0 except that it further comprises the state of the user plane connection.

In an embodiment, when the first request is a PDU session update request, the state of ACTIVATED, DEACTIVATED, ACTIVATING, or SUSPENDED can be comprised in the first request.

In an embodiment, when the first request is a PDU session create request, the state of ACTIVATING can be comprised in the first request.

In an embodiment, when the first request is a PDU session create request, the list of one or more PDU sessions to be activated can be comprised in the first request.

The state of the user plane connection may be indicated by any suitable information such as a bit, an indication, a flag, a state code, etc. In an embodiment, the ACTIVATED state (the ongoing user plane connection activation procedure is finished) may comprise at least one of a complete indication set to TRUE or a user plane connection state set to ACTIVATED. For example, the complete indication set to TRUE may be allowNWRequest set to TRUE. The user plane connection state set to ACTIVATED may be upCnxState set to ACTIVATED. The upCnxState has been described in 3GPP TS 29.502 V17.1.0.

The ACTIVATING state (i.e., the ongoing user plane connection activation procedure is activating) may be indicated by any suitable information such as a bit, an indication, a flag, a state code, etc. In an embodiment, the ACTIVATING state may comprise at least one of a complete indication set to FALSE or a user plane connection state set to ACTIVATING. For example, the complete indication set to FALSE may be allowNWRequest set to FALSE. The user plane connection state set to ACTIVATING may be upCnxState set to ACTIVATING.

In an embodiment, the first request may further comprise information on policy control request trigger condition. The information on policy control request trigger condition may comprise any suitable information which can be used by the second AMF to detect whether corresponding policy control request trigger(s) is met. For example, the information on policy control request trigger condition may comprise PLMN (Public Land Mobile Network) information, Access Type, UE IP address, UE MAC address, Access Network Information, UE location information, UE time zone, a serving network function identifier, Radio-Access-Technology (RAT) type, etc.

In an embodiment, the information on policy control request trigger condition comprises at least one of UE location information, a UE time zone, or a serving network function identifier. For example, the UE location information and the UE time zone may be same as those as described in 3GPP TS 29.502 V17.1.0.

At block 404, the first SMF may receive a first response from the second SMF.

The first response may be any suitable message which can be sent from the second SMF to the first SMF. In an embodiment, the first response may comprise a protocol data unit (PDU) session update response. For example, the first response may be Nsmf_PDUSession_Update response as described in 3GPP TS 23.502 V17.0.0.

In an embodiment, the first response may comprise a protocol data unit (PDU) session create response. For example, the first response may be Nsmf_PDUSession_Create response as described in 3GPP TS 23.502 V17.0.0.

In an embodiment, the first request is sent and the first response is received during a procedure of UE triggered service request with intermediate SMF (I-SMF) insertion or change, a procedure of UE triggered service request without I-SMF change or removal, inter access and mobility function (AMF) idle mobility with user plane (UP) connection activation with intermediate SMF (I-SMF) insertion or change, intra AMF idle mobility with UP connection activation with intermediate SMF (I-SMF) insertion or change, or Evolved Packet System (EPS) to Fifth Generation System (5GS) Idle mode mobility using N26 interface.

The procedure of user equipment (UE) triggered service request with intermediate SMF (I-SMF) insertion or change may be same or similar as the procedure of the UE Triggered Service Request with I-SMF insertion/change as described in clause 4.23.4.3 of 3GPP TS 23.502 V17.0.0. The procedure of UE triggered service request without I-SMF change or removal may be same or similar as the procedure of UE Triggered Service Request without I-SMF change/removal as described in clause 4.23.4.2 of 3GPP TS 23.502 V17.0.0. The inter access and mobility function (AMF) idle mobility with user plane (UP) connection activation with intermediate SMF (I-SMF) insertion or change or intra AMF idle mobility with UP connection activation with intermediate SMF (I-SMF) insertion or change may be similar to the corresponding procedures as described in 3GPP TS 23.502 V17.0.0. Evolved Packet System (EPS) to Fifth Generation System (5GS) Idle mode mobility using N26 interface may be similar to the corresponding procedures as described in clauses 4.11.1.3.3 or 4.11.1.3.3A of 3GPP TS 23.502 V17.0.0.

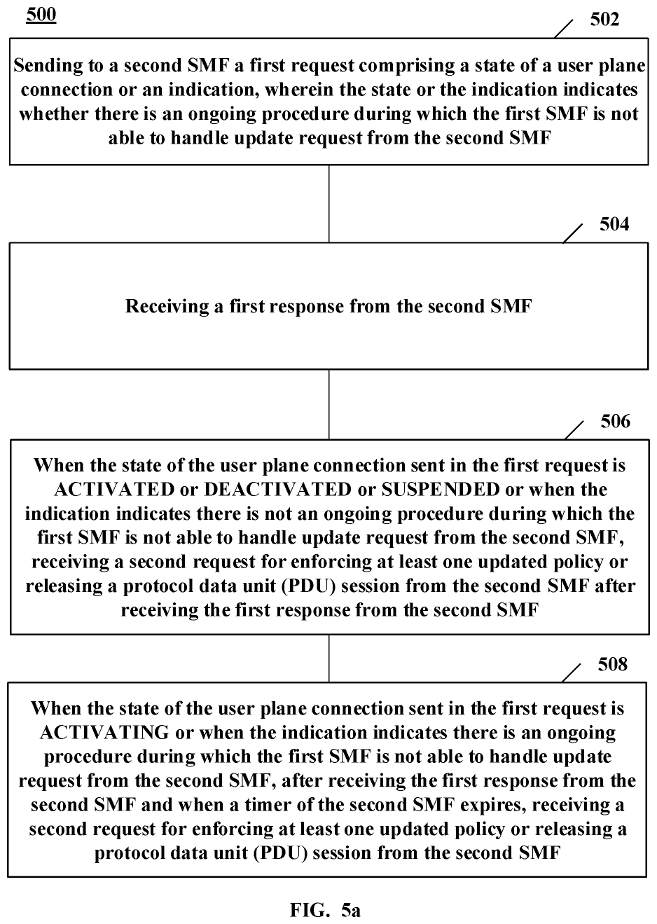

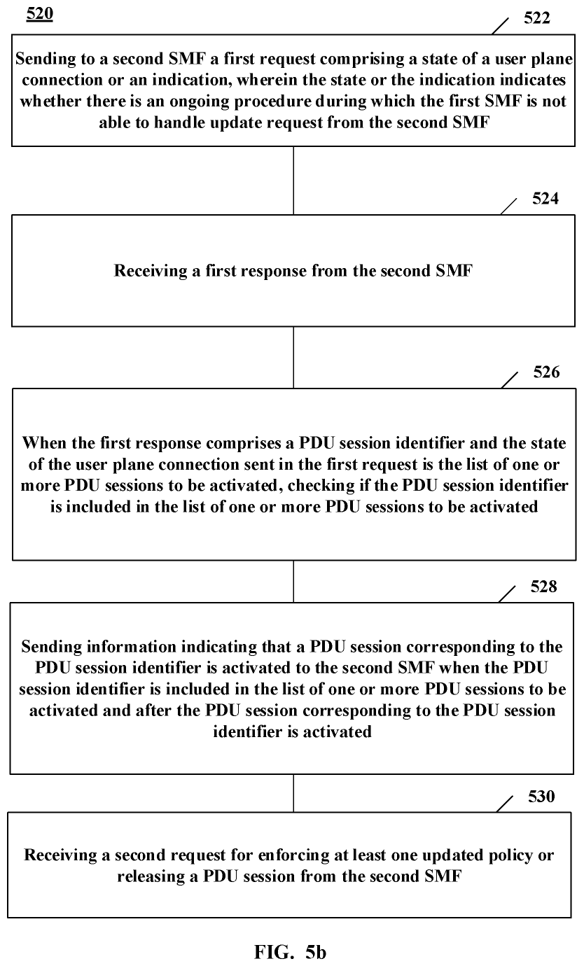

FIG. 5a shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 500 as well as means or modules for accomplishing other processes in conjunction with other components. The first SMF may be any suitable network device or node or entity or function which can provide session management function. For some parts which have been described in the above embodiments, the description thereof is omitted here for brevity.

At block 502, the first SMF may send to a second SMF a first request comprising a state of a user plane connection or an indication. The state or the indication indicates whether there is an ongoing procedure during which the first SMF is not able to handle update request from the second SMF. Block 502 is same as block 402 of FIG. 4.

At block 504, the first SMF may receive a first response from the second SMF. Block 504 is same as block 404 of FIG. 4.

At block 506, when the state of the user plane connection sent in the first request is ACTIVATED or DEACTIVATED or SUSPENDED or when the indication indicates there is not an ongoing procedure during which the first SMF is not able to handle update request from the second SMF, the first SMF may receive a second request for enforcing at least one updated policy or releasing a protocol data unit (PDU) session from the second SMF after receiving the first response from the second SMF. When the state of the user plane connection sent in the first request is ACTIVATING or when the indication indicates there is an ongoing procedure during which the first SMF is not able to handle update request from the second SMF, the second SMF may forbid sending the second request for enforcing at least one updated policy or releasing a protocol data unit (PDU) session to the first SMF. Blocks 502 and 504 may be performed several times. For example, the state of the user plane connection sent in the first request may be ACTIVATING when the user plane connection is ACTIVATING. After the user plane connection is ACTIVATED, the state of the user plane connection sent in the first request may be ACTIVATED.

At block 508, when the state of the user plane connection sent in the first request is ACTIVATING or when the indication indicates there is an ongoing procedure during which the first SMF is not able to handle update request from the second SMF, the first SMF may receive a second request for enforcing at least one updated policy or releasing a protocol data unit (PDU) session from the second SMF after receiving the first response from the second SMF and when a timer of the second SMF expires.

FIG. 5b shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 520 as well as means or modules for accomplishing other processes in conjunction with other components. The first SMF may be any suitable network device or node or entity or function which can provide session management function. For some parts which have been described in the above embodiments, the description thereof is omitted here for brevity.

At block 522, the first SMF may send to a second SMF a first request comprising a state of a user plane connection or an indication. The state or the indication indicates whether there is an ongoing procedure during which the first SMF is not able to handle update request from the second SMF. Block 522 is same as block 402 of FIG. 4. In this embodiment, the state of the user plane connection sent in the first request is the list of one or more PDU sessions to be activated.

At block 524, the first SMF may receive a first response from the second SMF. Block 524 is same as block 404 of FIG. 4. In this embodiment, the first response comprises a PDU session identifier.

At block 526, when the first response comprises a PDU session identifier and the state of the user plane connection sent in the first request is the list of one or more PDU sessions to be activated, the first SMF may check if the PDU session identifier is included in the list of one or more PDU sessions to be activated.

At block 528, the first SMF may send information indicating that a PDU session corresponding to the PDU session identifier is activated to the second SMF when the PDU session identifier is included in the list of one or more PDU sessions to be activated and after the PDU session corresponding to the PDU session identifier is activated.

At block 530, the first SMF may receive a second request for enforcing at least one updated policy or releasing a PDU session from the second SMF.

The second request may be any suitable message which can be sent from the second SMF to the first SMF. In an embodiment, the second request may be a PDU session update request. For example, the second message may be Nsmf_PDUSession_Update request as described in 3GPP TS 23.502 V17.0.0.

In an embodiment, the second request comprises at least one updated policy or PDU session release information. The first SMF may apply the at least one updated policy or perform PDU session release.

In an embodiment, the second request is received during a procedure of UE triggered service request with intermediate SMF (I-SMF) insertion or change, a procedure of UE triggered service request without I-SMF change or removal, inter access and mobility function (AMF) idle mobility with user plane (UP) connection activation with intermediate SMF (I-SMF) insertion or change, intra AMF idle mobility with UP connection activation with intermediate SMF (I-SMF) insertion or change, or Evolved Packet System (EPS) to Fifth Generation System (5GS) Idle mode mobility using N26 interface.

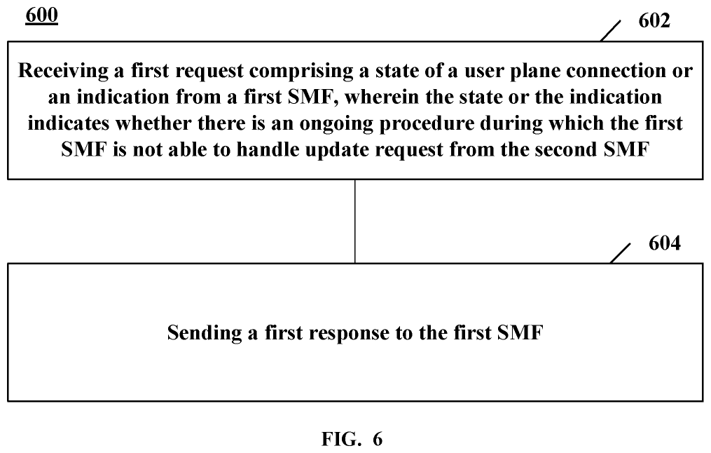

FIG. 6 shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 600 as well as means or modules for accomplishing other processes in conjunction with other components. The second SMF may be any suitable network device or node or entity or function which can provide session management function. For some parts which have been described in the above embodiments, the description thereof is omitted here for brevity.

At block 602, the second SMF may receive a first request comprising a state of a user plane connection or an indication from the first SMF. The state or the indication indicates whether there is an ongoing procedure during which the first SMF is not able to handle update request from the second SMF. For example, the first SMF may send the first request to the second SMF at block 402 of FIG. 4, and then the second SMF may receive the first request.

In an embodiment, the first request further comprises information on policy control request trigger condition. The at least one updated policy may be obtained from a policy control node by the second SMF based on the information on policy control request trigger condition. For example, as described in clause 4.16.5.1 of 3GPP TS 23.502 V17.0.0, the second SMF may initiate the SM Policy Association Modification procedure to obtain the at least one updated policy related to the activated user plane connection or the user plane connection being activated if a Policy Control Request Trigger is met.

At block 604, the second SMF may send a first response to the first SMF.

In this embodiment, the second SMF may obtain the state of the user plane connection and then may perform any suitable action based on the state of the user plane connection. For example, the second SMF may know whether it can enforce at least one updated policy or release a protocol data unit (PDU) session based on the state of the user plane connection. In this ways, the second SMF may send a suitable message to the first SMF which can also correctly handle the message.

In an embodiment, the first request is received and the first response is sent during a procedure of UE triggered service request with intermediate SMF (I-SMF) insertion or change, a procedure of UE triggered service request without I-SMF change or removal, inter access and mobility function (AMF) idle mobility with user plane (UP) connection activation with intermediate SMF (I-SMF) insertion or change, intra AMF idle mobility with UP connection activation with intermediate SMF (I-SMF) insertion or change, or Evolved Packet System (EPS) to Fifth Generation System (5GS) Idle mode mobility using N26 interface.

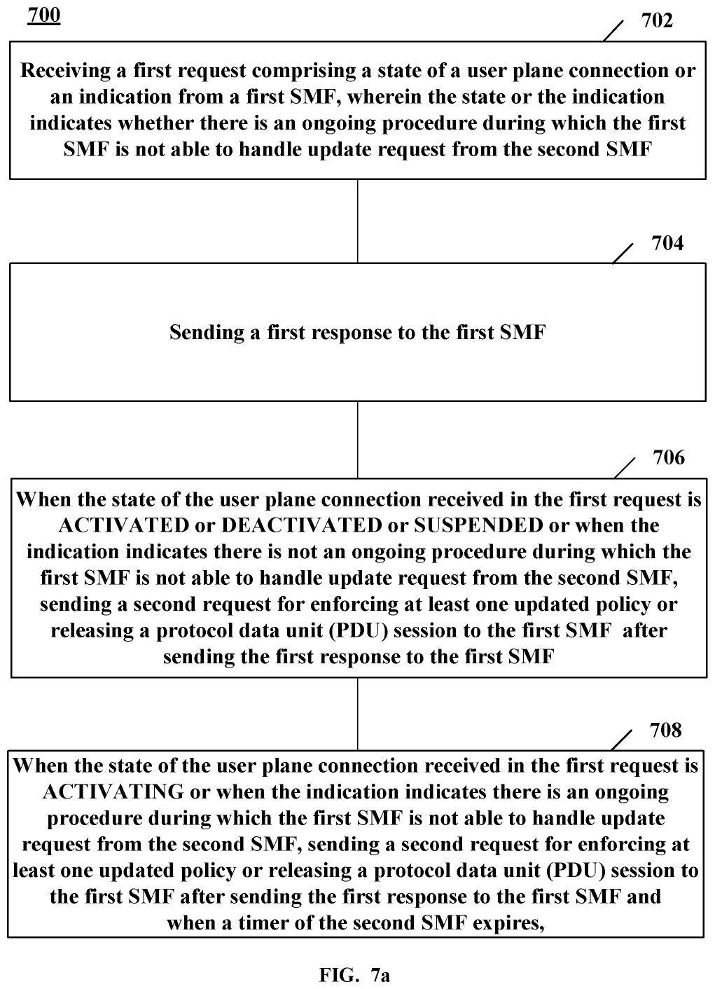

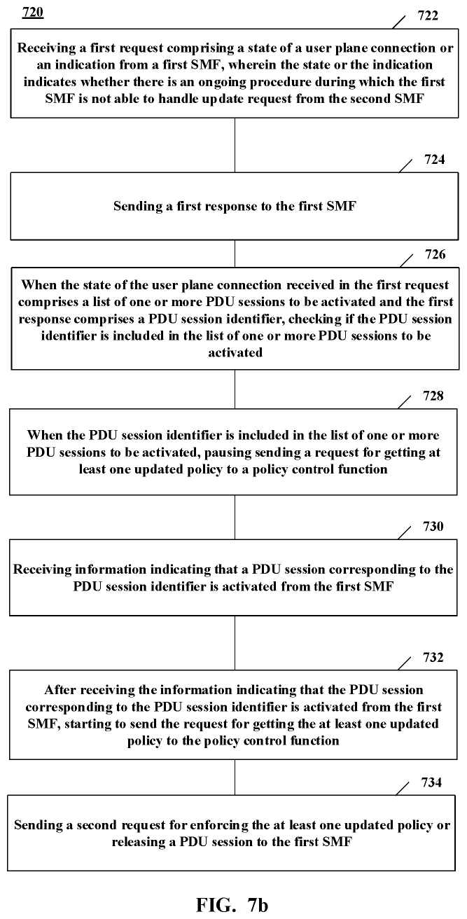

FIG. 7a shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 700 as well as means or modules for accomplishing other processes in conjunction with other components. The second SMF may be any suitable network device or node or entity or function which can provide session management function. For some parts which have been described in the above embodiments, the description thereof is omitted here for brevity.

At block 702, the second SMF may receive a first request comprising a state of a user plane connection or an indication from the first SMF. The state or the indication indicates whether there is an ongoing procedure during which the first SMF is not able to handle update request from the second SMF. Block 702 is same as block 602 of FIG. 6.

At block 704, the second SMF may send a first response to the first SMF. Block 704 is same as block 604 of FIG. 6.

At block 706, when the state of the user plane connection received in the first request is ACTIVATED or DEACTIVATED or SUSPENDED or when the indication indicates there is not an ongoing procedure during which the first SMF is not able to handle update request from the second SMF, the second SMF may send a second request for enforcing at least one updated policy or releasing a protocol data unit (PDU) session to the first SMF after sending the first response to the first SMF. In this case, the first SMF can handle the second request since the state of the user plane connection is ACTIVATED or DEACTIVATED or SUSPENDED or there is not an ongoing procedure during which the first SMF is not able to handle update request from the second SMF.

At block 708, when the state of the user plane connection received in the first request is ACTIVATING or when the indication indicates there is an ongoing procedure during which the first SMF is not able to handle update request from the second SMF, the second SMF may send a second request for enforcing at least one updated policy or releasing a protocol data unit (PDU) session to the first SMF after sending the first response to the first SMF and when a timer of the second SMF expires. The timer may be predefined or learned by machine learning. In other embodiments, the second SMF may forbid sending the second request.

FIG. 7b shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 720 as well as means or modules for accomplishing other processes in conjunction with other components. The second SMF may be any suitable network device or node or entity or function which can provide session management function. For some parts which have been described in the above embodiments, the description thereof is omitted here for brevity.

At block 722, the second SMF may receive a first request comprising a state of a user plane connection or an indication from the first SMF. The state or the indication indicates whether there is an ongoing procedure during which the first SMF is not able to handle update request from the second SMF. Block 722 is same as block 602 of FIG. 6. In this embodiment, the state of the user plane connection received in the first request comprises a list of one or more PDU sessions to be activated.

At block 724, the second SMF may send a first response to the first SMF. Block 704 is same as block 604 of FIG. 6. In this embodiment, the first response comprises a PDU session identifier.

At block 726, the second SMF may check if the PDU session identifier is included in the list of one or more PDU sessions to be activated.

At block 728, the second SMF may pause sending a request for getting at least one updated policy to a policy control function when the PDU session identifier is included in the list of one or more PDU sessions to be activated.

At block 730, the second SMF may receive information indicating that a PDU session corresponding to the PDU session identifier is activated (i.e., user plane is activated) from the first SMF.

At block 732, the second SMF may start to send the request for getting the at least one updated policy to the policy control function after receiving the information indicating that the PDU session corresponding to the PDU session identifier is activated from the first SMF.

At block 734, the second SMF may send a second request for enforcing the at least one updated policy or releasing a PDU session to the first SMF.

In an embodiment, the second request comprises at least one updated policy or PDU session release information. The second SMF may obtain the at least one updated policy at any suitable time point such as before or after receiving the first request. The at least one updated policy may be obtained from a policy control node by the second SMF in various ways. For example, as described in clause 4.16.5.1 of 3GPP TS 23.502 V17.0.0, the second SMF may initiate the SM Policy Association Modification procedure to obtain the at least one updated policy related to the activated user plane connection or the user plane connection being activated if a Policy Control Request Trigger is met. As described in clause 4.16.5.2 of 3GPP TS 23.502 V17.0.0, PCF may initiate SM Policy Association Modification to send the at least one updated policy related to the activated user plane connection or the user plane connection being activated to the second SMF.

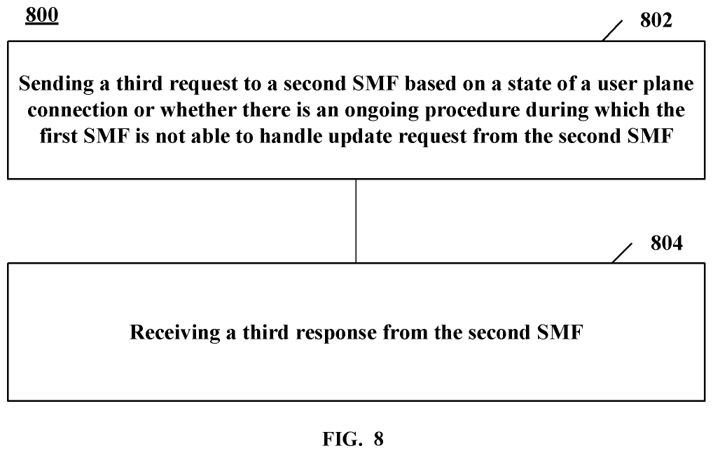

FIG. 8 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 800 as well as means or modules for accomplishing other processes in conjunction with other components. The first SMF may be any suitable network device or node or entity or function which can provide session management function. For some parts which have been described in the above embodiments, the description thereof is omitted here for brevity.

At block 802, the first SMF may send a third request to a second SMF based on a state of a user plane connection or whether there is an ongoing procedure during which the first SMF is not able to handle update request from the second SMF. For example, based on the state of the user plane connection or said information, the first SMF may know which third request can be sent to the second SMF or which information can be comprised in the third request such that the third request will not bring a negative impact (such as some subsequent messages cannot be handled by the first SMF or the second SMF or other related network node) for the following procedure.

The third request may be any suitable message which can be sent from the first SMF to the second SMF. In an embodiment, the third request may be a protocol data unit (PDU) session update request. For example, the third request may be Nsmf_PDUSession_Update request as described in 3GPP TS 23.502 V17.0.0. In another embodiment, the third request may be a protocol data unit (PDU) session create request. For example, the third request may be Nsmf_PDUSession_Create request as described in 3GPP TS 23.502 V17.0.0.

At block 804, the first SMF may receive a third response from the second SMF.

The third response may be any suitable message which can be sent from the second SMF to the first SMF. In an embodiment, the third response may comprise a protocol data unit (PDU) session update response. For example, the third response may be Nsmf_PDUSession_Update response as described in 3GPP TS 23.502 V17.0.0.

In an embodiment, when the state of the user plane connection is ACTIVATED or DEACTIVATED or SUSPENDED or when there is not an ongoing procedure during which the first SMF is not able to handle update request from the second SMF, the third request comprises information on policy control request trigger condition. As described above, the information on policy control request trigger condition can be used by the second SMF to obtain at least one updated policy related to the user plane connection from a policy control node.

In an embodiment, when the state of the user plane connection is ACTIVATING or when there is an ongoing procedure during which the first SMF is not able to handle update request from the second SMF, information on policy control request trigger condition is omitted in the third request.

In an embodiment, the third request is sent and the third response is received during a procedure of UE triggered service request with intermediate SMF (I-SMF) insertion or change, a procedure of UE triggered service request without I-SMF change or removal, inter access and mobility function (AMF) idle mobility with user plane (UP) connection activation with intermediate SMF (I-SMF) insertion or change, or intra AMF idle mobility with UP connection activation with intermediate SMF (I-SMF) insertion or change.

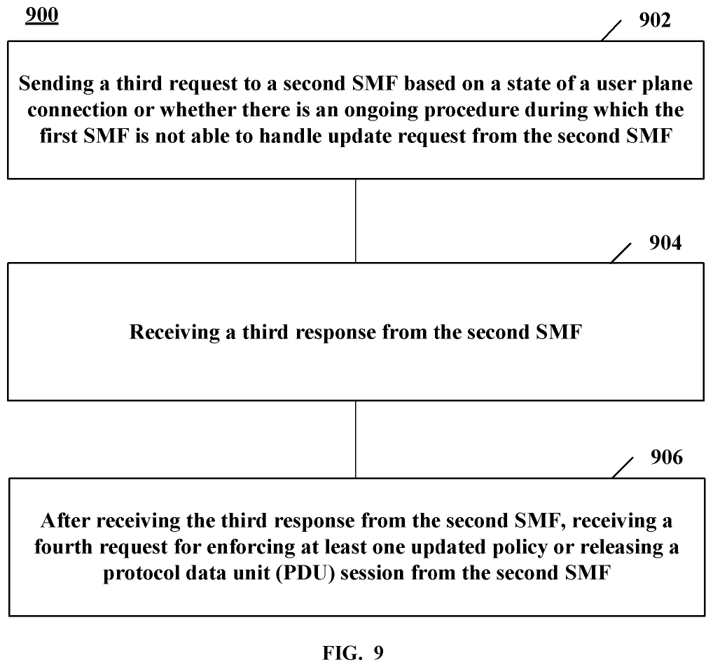

FIG. 9 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 900 as well as means or modules for accomplishing other processes in conjunction with other components. The first SMF may be any suitable network device or node or entity or function which can provide session management function. For some parts which have been described in the above embodiments, the description thereof is omitted here for brevity.

At block 902, the first SMF may send a third request to a second SMF based on a state of a user plane connection or whether there is an ongoing procedure during which the first SMF is not able to handle update request from the second SMF. Block 902 is same as block 802 of FIG. 8.

At block 904, the first SMF may receive a third response from the second SMF. Block 904 is same as block 804 of FIG. 8.

At block 906, the first SMF may receive a fourth request for enforcing at least one updated policy or releasing a protocol data unit (PDU) session from the second SMF after receiving the third response from the second SMF. For example, the third request comprises information on policy control request trigger condition, and the first SMF may receive the fourth request for enforcing at least one updated policy or releasing a protocol data unit (PDU) session from the second SMF after receiving the third response from the second SMF.

The fourth request may be any suitable message which can be sent from the second SMF to the first SMF. In an embodiment, the fourth request may be a protocol data unit (PDU) session update request. For example, the fourth request may be Nsmf_PDUSession_Update request as described in 3GPP TS 23.502 V17.0.0.

In an embodiment, the fourth request comprises at least one updated policy or PDU session release information. As described above the second SMF may obtain the at least one updated policy in various ways and comprise it in the fourth request.

In an embodiment, the fourth request is received during a procedure of UE triggered service request with intermediate SMF (I-SMF) insertion or change, a procedure of UE triggered service request without I-SMF change or removal, inter access and mobility function (AMF) idle mobility with user plane (UP) connection activation with intermediate SMF (I-SMF) insertion or change, or intra AMF idle mobility with UP connection activation with intermediate SMF (I-SMF) insertion or change.

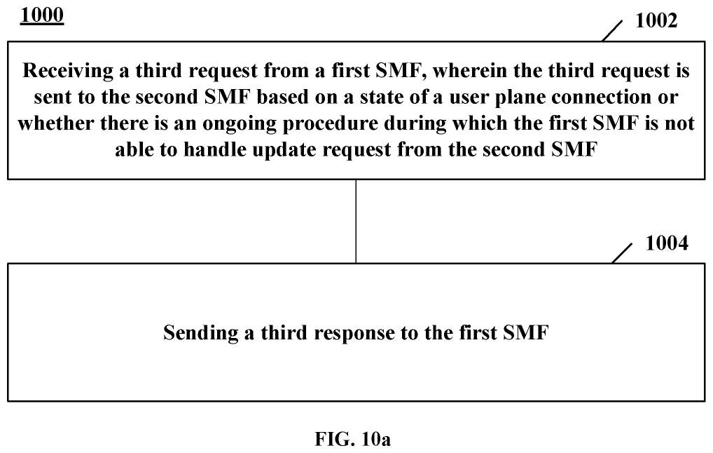

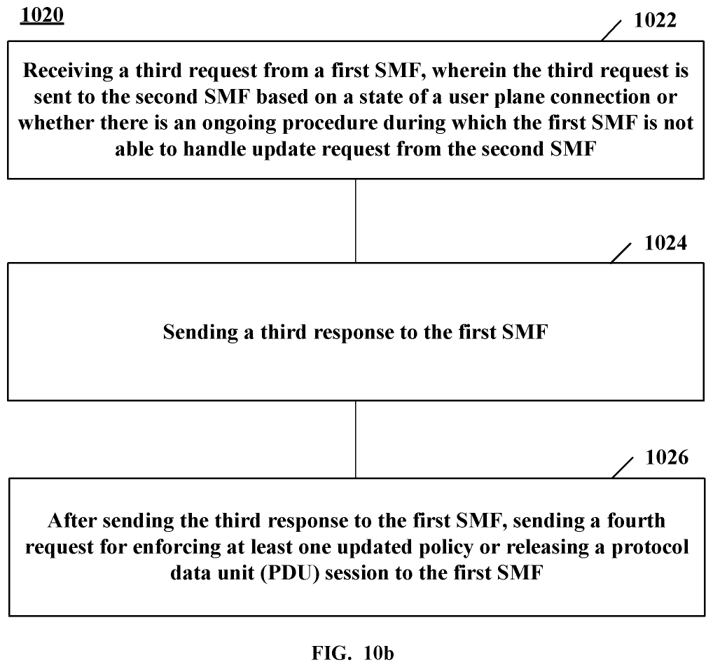

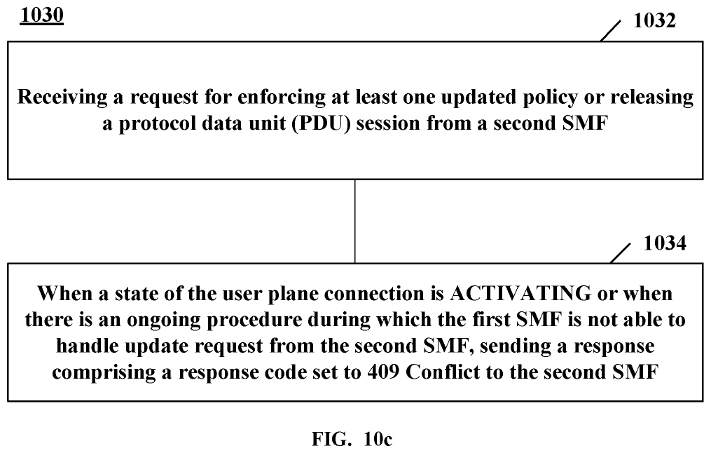

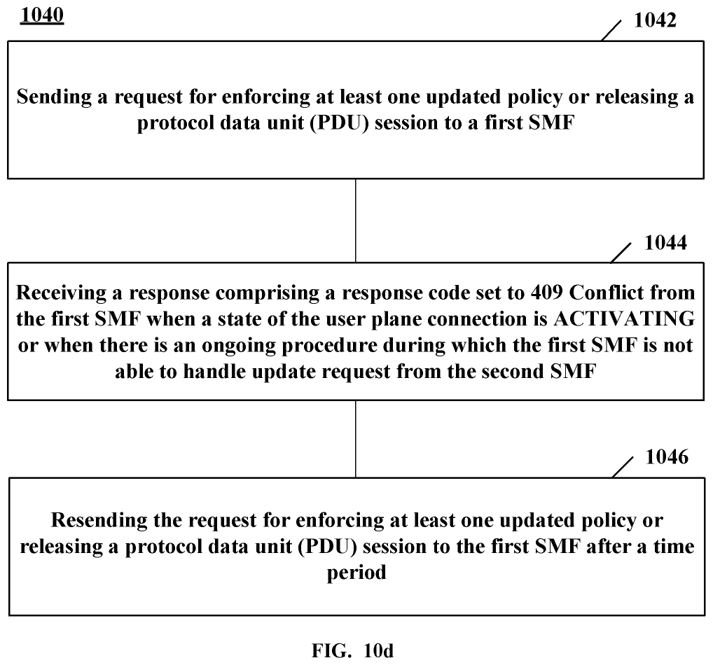

FIG. 10a shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 1000 as well as means or modules for accomplishing other processes in conjunction with other components. The second SMF may be any suitable network device or node or entity or function which can provide session management function. For some parts which have been described in the above embodiments, the description thereof is omitted here for brevity.

At block 1002, the second SMF may receive a third request from a first SMF. The third request is sent to the second SMF based on a state of a user plane connection or whether there is an ongoing procedure during which the first SMF is not able to handle update request from the second SMF. For example, the first SMF may send the third request at block 802 of FIG. 8, and then the second SMF may receive the third request.

At block 1004, the second SMF may send a third response to the first SMF.

FIG. 10b shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 1020 as well as means or modules for accomplishing other processes in conjunction with other components. The second SMF may be any suitable network device or node or entity or function which can provide session management function. For some parts which have been described in the above embodiments, the description thereof is omitted here for brevity.

At block 1022, the second SMF may receive a third request from a first SMF. The third request is sent to the second SMF based on a state of a user plane connection or whether there is an ongoing procedure during which the first SMF is not able to handle update request from the second SMF. Block 1022 is same as block 1002 of FIG. 10.

At block 1024, the second SMF may send a third response to the first SMF. Block 1024 is same as block 1004 of FIG. 10.

At block 1026, the second SMF may send a fourth request for enforcing at least one updated policy or releasing a protocol data unit (PDU) session to the first SMF after sending the third response to the first SMF. For example, when the third request comprises information on policy control request trigger condition, the second SMF may send a fourth request for enforcing at least one updated policy or releasing a protocol data unit (PDU) session to the first SMF after sending the third response to the first SMF.

FIG. 10c shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 1030 as well as means or modules for accomplishing other processes in conjunction with other components. The first SMF may be any suitable network device or node or entity or function which can provide session management function. For some parts which have been described in the above embodiments, the description thereof is omitted here for brevity.

At block 1032, the first SMF may receive a request for enforcing at least one updated policy or releasing a protocol data unit (PDU) session from a second SMF. In an embodiment, the request may be a PDU session update request such as Nsmf_PDUSession_Update request as described in 3GPP TS 23.502 V17.0.0.

In an embodiment, the first SMF is an I-SMF and the second SMF is an SMF.

In an embodiment, the first SMF is a visited SMF and the second SMF is a home SMF.

At block 1034, the first SMF may send a response comprising a response code set to 409 Conflict to the second SMF when a state of the user plane connection is ACTIVATING or when there is an ongoing procedure during which the first SMF is not able to handle update request from the second SMF. In an embodiment, the response may be a PDU session update response such as Nsmf_PDUSession_Update response as described in 3GPP TS 23.502 V17.0.0.

In an embodiment, the request is received and the response is sent during a procedure of UE triggered service request with intermediate SMF (I-SMF) insertion or change, a procedure of UE triggered service request without I-SMF change or removal, inter access and mobility function (AMF) idle mobility with user plane (UP) connection activation with intermediate SMF (I-SMF) insertion or change, or intra AMF idle mobility with UP connection activation with intermediate SMF (I-SMF) insertion or change.

FIG. 10d shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 1040 as well as means or modules for accomplishing other processes in conjunction with other components. The second SMF may be any suitable network device or node or entity or function which can provide session management function. For some parts which have been described in the above embodiments, the description thereof is omitted here for brevity.

At block 1042, the second SMF may send a request for enforcing at least one updated policy or releasing a protocol data unit (PDU) session to a first SMF. In an embodiment, the request may be a PDU session update request such as Nsmf_PDUSession_Update request as described in 3GPP TS 23.502 V17.0.0.

At block 1044, the second SMF may receive a response comprising a response code set to 409 Conflict from the first SMF when a state of the user plane connection is ACTIVATING or when there is an ongoing procedure during which the first SMF is not able to handle update request from the second SMF. In an embodiment, the response may be a PDU session update response such as Nsmf_PDUSession_Update response as described in 3GPP TS 23.502 V17.0.0. In other embodiments, the response code may be any other suitable response code which can cause the second SMF to resend the request for enforcing at least one updated policy or releasing a protocol data unit (PDU) session to the first SMF after a time period.

At block 1046, the second SMF may resend the request for enforcing at least one updated policy or releasing a protocol data unit (PDU) session to the first SMF after a time period. The time period may be any suitable time period. The time period may be configured by an operator or learned by machine learning. In an embodiment, the second SMF may start a timer and keep retry after it receives the response with the response code of 409 Conflict.

In an embodiment, the request is sent and the response is received during a procedure of UE triggered service request with intermediate SMF (I-SMF) insertion or change, a procedure of UE triggered service request without I-SMF change or removal, inter access and mobility function (AMF) idle mobility with user plane (UP) connection activation with intermediate SMF (I-SMF) insertion or change, or intra AMF idle mobility with UP connection activation with intermediate SMF (I-SMF) insertion or change.

FIG. 11 shows a flowchart of inter AMF idle mode mobility with UP connection activating and I_SMF insertion according to another embodiment of the present disclosure.

Step 1101: UE initiates the Registration procedure and step 1 to 16 in registration procedure in clause 4.2.2.2 in 3GPP TS 23.502 V17.0.0 is applied.

Step 1102: New AMF decides to insert I_SMF based on UE location and service area of the SMF.

Step 1103: New AMF sends Nsmf_PDUSession_CreateSMContext Request (upCnxState=ACTIVATING and/or ULI and/or Timezone) to I_SMF when it determines to insert an I_SMF based on UE location and service area of the SMF.

Step 1104 and Step 1105: I_SMF retrieves SM Context from the SMF by invoking Nsmf_PDUSession_Context Request (SM context type, SM Context ID).

Step 1106: I_SMF selects I_UPF.

Step 1107: I_SMF initiates a PFCP (Packet Forwarding Control Protocol) Session Establishment to the new I_UPF and the new I_UPF allocates N3 and N9 tunnel endpoints to I_SMF.

Step 1108: I_SMF invokes Nsmf_PDUSession_Create Request (UE location information and/or Time Zone) towards the SMF.

Step 1109: SMF may notify the UE location information (ULI) and/or UE Time Zone and/or serving network function identifier to PCF and get the updated policy if dynamic PCC is deployed.

Step 1110: SMF invokes PFCP Session Modification (FAR (Forwarding Action Rule) DL (downlink) to I_UPF N9, remove N3 and allocate UL N9) procedure to UPF.

Step 1111: SMF sends Nsmf_PDUSession_Create Response to I_SMF.

Block 1112: I_SMF enforces new policies to I_SMF.

Step 1113: SMF sends Nsmf_PDUSession_Update Request (VsmfUpdateData) to I_SMF to notify the updated policy.

Step 1114: I_SMF responds failed Nsmf_PDUSession_Update Response to SMF with “Response codes” 409 (Conflict) while UP connection activating is ongoing.

Step 1115: SMF starts timer to retry after receiving response code of 409.

Step 1116: I_SMF invokes a PFCP Session Modification request to I_UPF.

Step 1117: I_SMF sends Nsmf_PDUSession_CreateSMContext Response (upCnxState=ACTIVATING, n2SmInfo=PDU_RES_SETUP_REQ) to AMF.

Step 1118: New_AMF sends Nsmf_PDUSession_UpdateSMContext Request to I_SMF.

Step 1119: I_SMF invokes a PFCP Session Modification request to I_UPF.

Step 1120: I_SMF sends Nsmf_PDUSession_UpdateSMContext Response (upCnxState=ACTIVATED) to New_AMF.

Step 1121: Timer in step 1115 is up.

Step 1122: SMF retries to enforce the updated policy to I_SMF after timer in step 15 is up and this step may happen many times.

The steps 1114, 1115, 1121 and 1122 are enhanced according to the embodiments of the present disclosure. The other steps may be similar or same as the corresponding steps as described in 3GPP TS 23.502 V17.0.0.

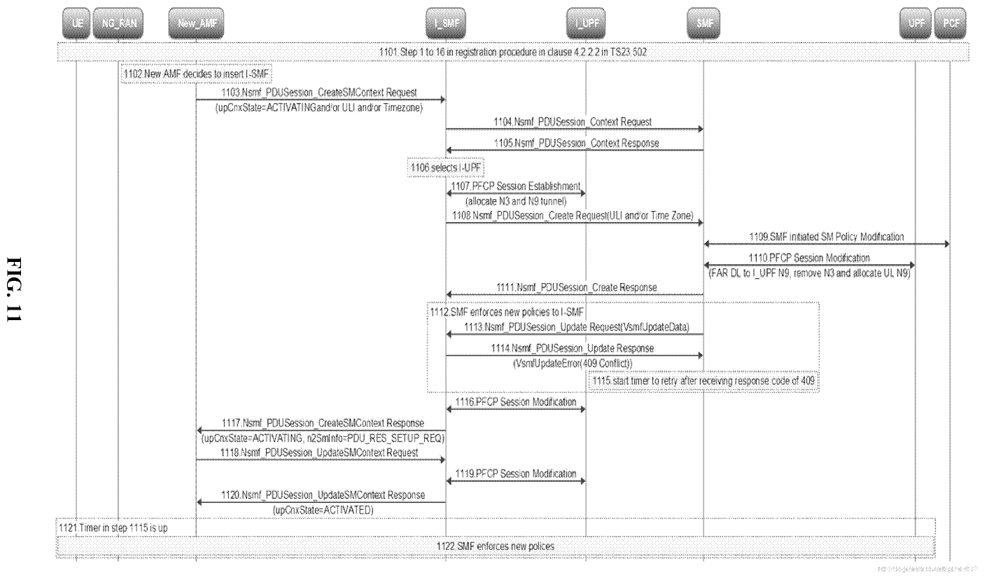

FIG. 12 shows a flowchart of inter AMF idle mode mobility with UP connection activating and I_SMF insertion according to an embodiment of the present disclosure.

Step 1201: UE initiates the Registration procedure and step 1 to 16 in registration procedure in clause 4.2.2.2 in 3GPP TS 23.502 V17.0.0 is applied.

Step 1202: New AMF decides to insert I_SMF.

Step 1203: New_AMF sends Nsmf_PDUSession_CreateSMContext Request (upCnxState=ACTIVATING, ULI and/or Timezone) to I_SMF when it determines to insert an I_SMF based on UE location and service area of the SMF.

Step 1204: I_SMF sends Nsmf_PDUSession_Context Request (SM context type, SM Context ID) to SMF to retrieve SM Context from the SMF.

Step 1205: SMF sends Nsmf_PDUSession_Context Response to I_SMF.

Step 1206: I_SMF selects I_UPF.

Step 1207: I_SMF initiates a PFCP Session Establishment to the new I_UPF and the new I_UPF allocates N3 and N9 tunnel endpoints to I_SMF.

Step 1208: I_SMF invokes Nsmf_PDUSession_Create Request (new I_UPF DL tunnel information, allowNWRequest-FALSE or existing upCnxState=ACTIVATING, ULI and/or Time Zone) towards the SMF. I_SMF provides the UE location and/or Time Zone to SMF while SMF will not interact with PCF even if dynamic PCC is deployed and USER_LOCATION_CH trigger or TIMEZONE_CHANGE trigger is installed since I_SMF indicates SMF with allowNWRequest=FALSE or upCnxState=ACTIVATING, i.e., the UP connection activating is ongoing. SMF may start a timer to wait for the completion indication.

Step 1209: SMF initiates PFCP Session Modification (FAR DL to I_UPF N9, remove N3 and allocate UL N9) toward the PDU session Anchor UPF.

Step 1210: SMF sends Nsmf_PDUSession_Create Response (Tunnel Info at UPF (PSA) for UL data) to I_SMF.

Step 1211: I_SMF invokes a PFCP Session Modification request to I_UPF to update I_UPF with the UL N9 tunnel endpoints.

Step 1212: I_SMF sends Nsmf_PDUSession_CreateSMContext Response (upCnxState=ACTIVATING, n2SmInfo=PDU_RES_SETUP_REQ) to New_AMF.

Step 1213: New_AMF sends Nsmf_PDUSession_UpdateSMContext Request (N2 SM information) to I_SMF after it gets the N2 SM information from (R)AN.

Step 1214: I_SMF invokes a PFCP Session Modification request to I_UPF to update the new I_UPF with the AN Tunnel Information.

Bock 1215: I_SMF notifies completed status to SMF.

Step 1216: I_SMF sends Nsmf_PDUSession_Update Request (allowNWRequest=TRUE or upCnxState=ACTIVATED) to SMF to notify SMF that UP connection activating is finished.

Step 1217: After receiving allowNWRequest=TRUE or upCnxState=ACTIVATED and if dynamic PCC is deployed, SMF stops the timer set in step 1209 and initiates notification about new UE location information and/or Time Zone and/or the new serving network function to the PCF (if subscribed) by performing an SMF initiated SM Policy Modification procedure. The PCF may provide updated policies. SMF could handle another procedure, e.g., invoking the Nsmf_PDUSession_Update Request service operation towards I_SMF for enforcing new policies. Then SMF interacts with PCF and/or CHF and may enforce new policies.

Step 1218: SMF sends Nsmf_PDUSession_Update Response to I_SMF.

Step 1219: I_SMF sends Nsmf_PDUSession_UpdateSMContext Response (upCnxState=ACTIVATED) to New_AMF.

Step 1220: SMF may enforce new polices if it gets from PCF in step 1217.

The steps 1208, 1216 and 1217 are enhanced according to the embodiments of the present disclosure. The other steps may be similar or same as the corresponding steps as described in 3GPP TS 23.502 V17.0.0.

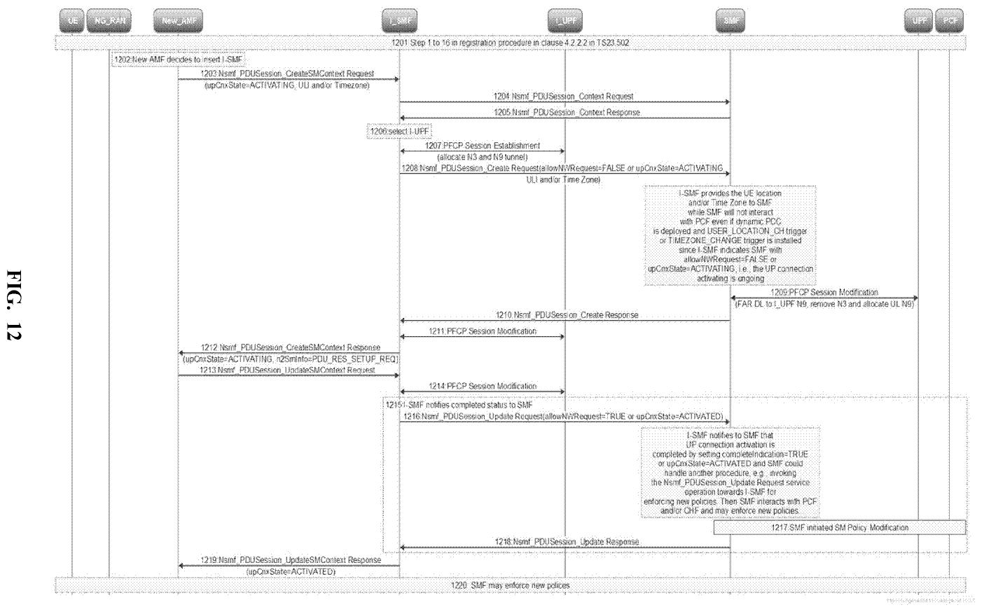

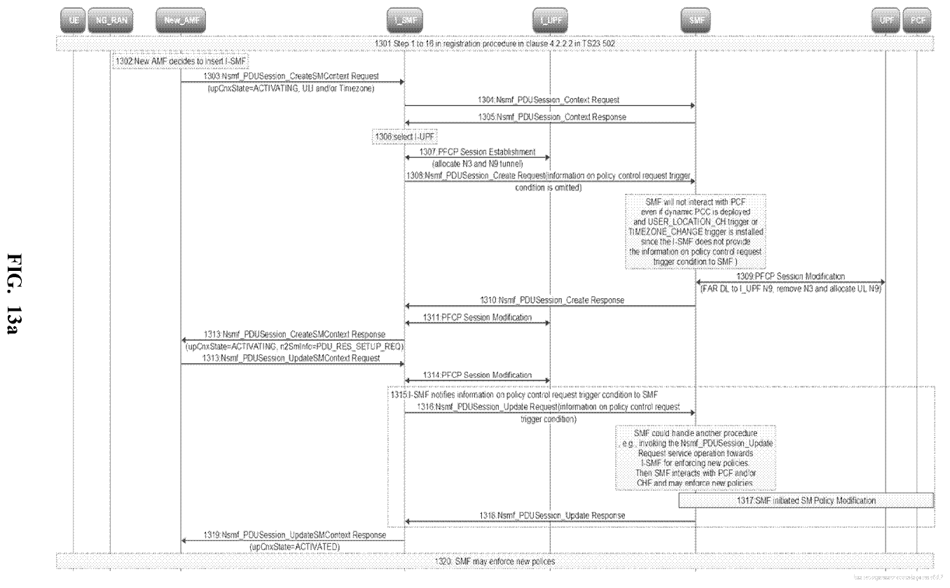

FIG. 13a shows a flowchart of inter AMF idle mode mobility with UP connection activating and I_SMF insertion according to another embodiment of the present disclosure.

Step 1301: UE initiates the Registration procedure and step 1 to 16 in registration procedure in clause 4.2.2.2 in 3GPP TS 23.502 V17.0.0 is applied.

Step 1302: New AMF decides to insert I_SMF.

Step 1303: New AMF sends Nsmf_PDUSession_CreateSMContext Request (upCnxState=ACTIVATING, ULI and/or Timezone) to I_SMF when it determines to insert an I_SMF based on UE location and service area of the SMF.

Step 1304: I_SMF sends Nsmf_PDUSession_Context Request (SM context type, SM Context ID) to SMF to retrieve SM Context from the SMF.

Step 1305: SMF sends Nsmf_PDUSession_Context Response to I_SMF.

Step 1306: I_SMF selects I_UPF.

Step 1307: I_SMF initiates a PFCP Session Establishment to the new I_UPF and the new I_UPF allocates N3 and N9 tunnel endpoints to I_SMF.

Step 1308: I_SMF invokes Nsmf_PDUSession_Create Request (information on policy control request trigger condition is omitted) towards the SMF. SMF will not interact with PCF even if dynamic PCC is deployed and USER_LOCATION_CH trigger or TIMEZONE_CHANGE trigger is installed since the I-SMF does not provide the information on policy control request trigger condition to SMF.

Step 1309: SMF initiates N4 Session Modification toward the PDU session Anchor UPF.

Step 1310: SMF sends Nsmf_PDUSession_Create Response (Tunnel Info at UPF (PSA) for UL data) to I_SMF.

Step 1311: I_SMF invokes a PFCP Session Modification request to I_UPF to update I_UPF with the UL N9 tunnel endpoints.

Step 1312: I_SMF sends Nsmf_PDUSession_CreateSMContext Response (upCnxState=ACTIVATING, n2SmInfo=PDU_RES_SETUP_REQ) to New_AMF.

Step 1313: New_AMF sends Nsmf_PDUSession_UpdateSMContext Request (N2 SM information) to I_SMF after it gets the N2 SM information from (R)AN.

Step 1314: I_SMF invokes a PFCP Session Modification request to I_UPF to update the new I_UPF with the AN Tunnel Information.

Bock 1315: I_SMF notifies information on policy control request trigger condition to SMF.

Step 1316: I_SMF sends Nsmf_PDUSession_Update Request (information on policy control request trigger condition) to SMF to notify SMF that UP connection activating is finished.

Step 1317: After receiving the information on policy control request trigger condition and if dynamic PCC is deployed, SMF initiates notification the information on policy control request trigger condition (such as new UE location information and/or Time Zone and/or the new serving network function) to the PCF (if subscribed) by performing an SMF initiated SM Policy Modification procedure. The PCF may provide updated policies. SMF could handle another procedure, e.g., invoking the Nsmf_PDUSession_Update Request service operation towards I_SMF for enforcing new policies. Then SMF interacts with PCF and/or CHF and may enforce new policies.

Step 1318: SMF sends Nsmf_PDUSession_Update Response to I_SMF.

Step 1319: I_SMF sends Nsmf_PDUSession_UpdateSMContext Response (upCnxState=ACTIVATED) to New_AMF.

Step 1320: SMF may enforce new polices if it gets from PCF in step 1317.

The steps 1308, 1316 and 1317 are enhanced according to the embodiments of the present disclosure. The other steps may be similar or same as the corresponding steps as described in 3GPP TS 23.502 V17.0.0.

FIG. 13b shows a flowchart of EPS to 5GS Idle mobility using N26 interface with List of one or more PDU sessions To Be Activated according to another embodiment of the present disclosure.

Step 1: UE initiates the Registration procedure.

Step 2: UE sends a registration request to NGRAN.

Step 3: NGRAN performs AMF selection,

Step 4: NGRAN sends the registration request to AMF.

Step 5: AMF sends context request to MME.

Step 6: MME sends context response to AMF.

Step 7: AMF sends context acknowledge to MME.

Step 8: AMF to UDM UECM/SDM interaction

Step 9: AMF to PCF interaction

Step 10: AMF sends Nsmf_PDUSession_CreateSMContext Request (ueEpsPdnConnection,pduSessionActivateList) to I_SMF (V-SMF).

Step 11: I-SMF sends N4 Session Establishment Request to I-UPF.

Step 12: I-UPF sends N4 Session Establishment Response to I-SMF.

Step 13: I-SMF sends Nsmf_PDUSession_Create Request (Option type “UE active” including pduSessionActiveList) to PGW_C_SMF (A-SMF or H-SMF or PGW-C+SMF).

Step 14: PGW_C_SMF interacts with HSS_UDM by invoking Nudm_SDM_Get service operation.

Step 15: PGW_C_SMF interacts with HSS_UDM by invoking Nudm_SDM_Subscribe service operation.

Step 16: PGW_C_SMF sends N4 Session Modification Request to PGW_U_UPF.

Step 17: PGW_C_SMF receives N4 Session Modification Response from PGW_U_UPF.

Step 18: PGW_C_SMF sends Nsmf_PDUSession_Create Response including PDU Session ID to I-SMF.

PGW_C_SMF checks current pduSessionId and pduSessionActiveList:
If pduSessionId is in the pduSessionActiveList, talk to PCF after receiving the indication from I-SMF to set “UP activated”,
If pduSessionId is not in the pduSessionActiveList, just talk to PCF immediately after mobility.
   I-SMF Checks Returned pduSessionId:
If it is in the pduSessionActiveList, start UP activation procedure. After UP activation is finished, I-SMF sends the indicator “UP activated” to A-SMF
If it is not in the pduSessionActiveList, I-SMF doesn't need to send the indicator to A-SMF

Step 19: I-SMF sends N4 Session Modification Request to I-UPF.

Step 20: I-SMF receives N4 Session Modification Response from I-UPF.

Step 21: I-SMF sends Nsmf_PDUSession_CreateSMContext Response (pduSessionId, allocatedEbiList, upCnxState=ACTIVATING, N2 PDU Session resource Setup request) to AMF.

Step 22: PDU Session Resource Setup between NGRAN and AMF.

Step 23: AMF sends Nsmf_PDUSession_Update SMContext Request (N2 PDU Session Resource setup Response) to I-SMF.

Step 24: N4 Session Modification between I-SMF and I_UPF.

Step 25: I-SMF sends Nsmf_PDUSession_Update SMContext Response) to AMF.

Step 26: I-SMF sends Nsmf_PDUSession_Update Request (The Operation Type is set to “UP activated”) to PGW_C_SMF

Step 27: PGW_C_SMF sends Npcf_SMPolicyControl_Update Request to PCF.

Step 28: PCF sendsNpcf_SMPolicyControl_Update Response to PGW_C_SMF.

Step 29: AMF sends Registration Accept to UE.

The steps 13, 18 and 26 FIG. 13b are enhanced according to the embodiments of the present disclosure. The messages in other steps may be similar or same to/as the corresponding messages as described in 3GPP TS 23.502 V17.0.0 or 3GPP TS 23.401 V17.2.0, the disclosure of which is incorporated by reference herein in its entirety.

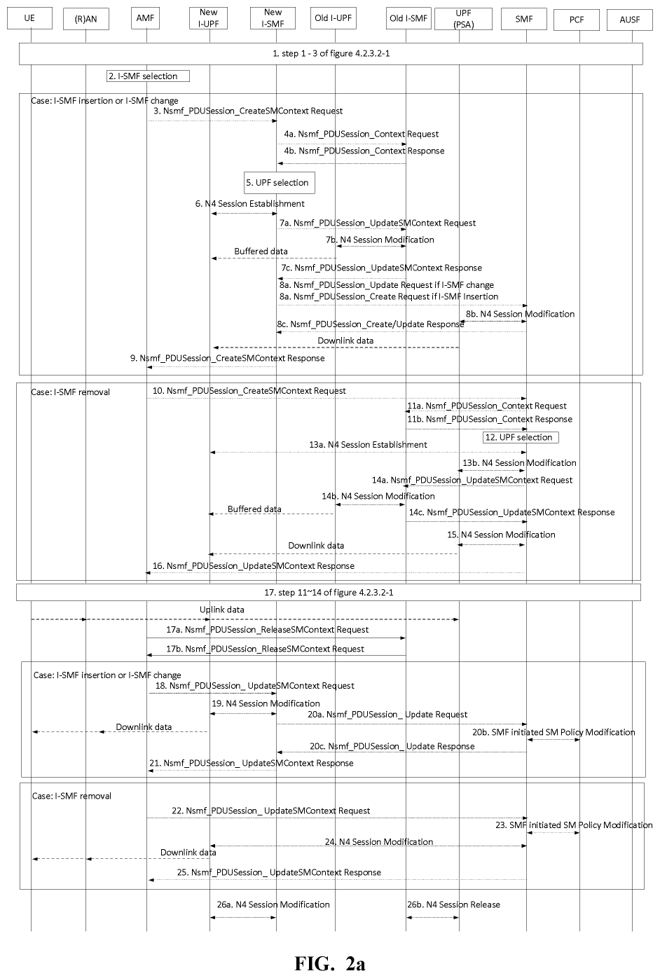

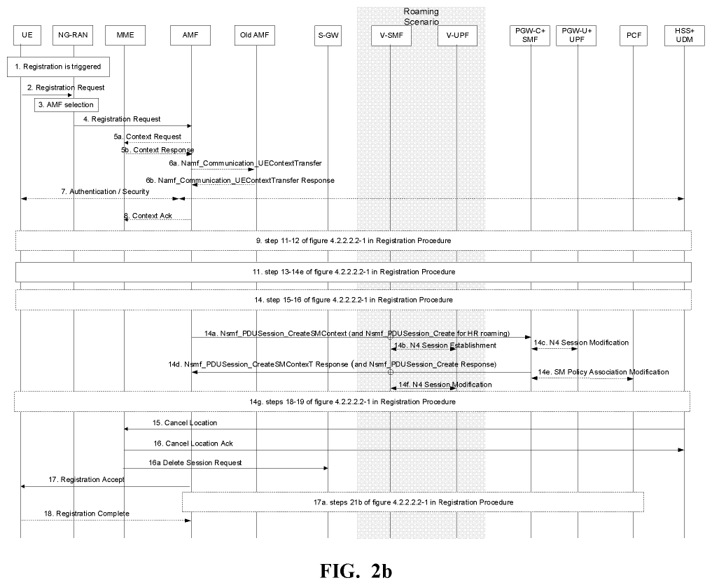

In an embodiment, steps 14-14f of FIG. 2b may be amended as following.

14-14f. Step 16 of clause 4.2.2.2.2 (AM Policy Association Establishment) is optionally performed.

In the home-routed roaming case and connected state mobility, based on the S-NSSAI value for the Serving PLMN of the PDU Session(s), the AMF decides whether V-SMF change is needed or not. If the V-SMF reallocation is not needed, and if the two values (i.e. the S-NSSAI value configured in AMF for interworking and S-NSSAI value for the Serving PLMN) are different, the AMF invokes Nsmf_PDUSession_UpdateSMContext (PDU Session ID, S-NSSAI value for the Serving PLMN). The V-SMF updates 5G AN with the new S-NSSAI of VPLMN by sending a N2 SM message to 5G AN via AMF. If the V-SMF change is needed, the AMF performs as the case of I-SMF change defined in clause 4.23.4.3 with the difference that I-SMF in clause 4.23.4.3 is replaced by V-SMF and with following modifications:
In step 3 of clause 4.23.4.3, the AMF sends indication of no NG-RAN change to the new V-SMF.
In step da of clause 4.23.4.3, when the new V-SMF retrieves SM context from the old V-SME, the new V-SMF sends indication of no NG-RAN change as it is received in step 3.
In step 4b of clause 4.23.4.3, as the old V-SMF receives the indication of no NG-RAN change, the old V-SMF returns additional N3 tunnel information of NG-RAN.
In step 6 of clause 4.23.4.3, the new I-SMF should reuse the N3 tunnel information of NG-RAN received from old I-SMF SMF.
In step 9 of clause 4.23.4.3, when the new V-SMF sends a Nsmf_PDUSession_CreateSMContext Response, the new V-SMF includes PDU Session Resource Modify in N2 SM information.

In the home-routed roaming case and idle state mobility, the AMF selects a default V-SMF per PDU Session and invokes Nsmf_PDUSession_CreateSMContext service operation of the V-SMF to create an association with the AMF. It includes UE EPS PDN Connection, H-SMF ID, S-NSSAI and indicates all the PDU Session(s) to be re-activated as received in the Registration request message along with List Of PDU Sessions To Be Activated. The S-NSSAI is the S-NSSAI configured in AMF for interworking, which is associated with default V-SMF. The V-SMF creates the association and based on the received SMF ID, the V-SMF invokes Nsmf_PDUSession_Create request service operation of the H-SMF and provides the information received from the AMF including the List Of PDU Sessions To Be Activated. Before invoking PDUSession_Create service operation, the V-SME request the V-UPF to provide the ON tunnel info.

The subsequent handling is performed as follows:
The H-SMF finds the corresponding PDU Session based on the PDN Connection Context in the request. The H-SMF initiates N4 Session modification procedure to establish the CN tunnel for the PDU Session. The tunnel info for PDU Session is allocated by PGW-U. UPF and provided to the SMF PGW-C. The H-SMF responds V-SMF with the PDU Session ID) corresponding to the PDN Connection Context in the request, the allocated EBI(s) information, the S-NSSAI of the PDU Session, S-NSSAI of HPLMN, UE EPS PDN connection(s), and other PDU session parameters, such as PDU Session Type, Session AMBR in the Nsmf_PDUSession_Create response.
The V-SMF updates its SM contexts and returns a Nsmf_PDU_Session_CreateSMContextResponse message including the information received from the H-SMF. The V-SMF updates the V-UPF of the ON tunnel info of SMF PGW-C. The V-SMF also includes the N2 SM Context in the response message sent to the AMF if the corresponding PDU Session is in the received List Of PDU Sessions To Be Activated. The V-SMF stores an association of the PDU Session ID and the H-SMF ID. The AMF stores the V-SMF ID and it also stores S-NSSAI and the allocated EBI(s) associated to the PDU Session ID. Based on the S-NSSAI value for the Serving PLMN of the PDU Session(s) the AMF decides whether V-SMF relocation is needed or not. If V-SMF relocation is not needed, and if the two values (i.e. the S-NSSAI value configured in AMF for interworking and S-NSSAI value for the Serving PLMN) are different, the AMF sends the S-NSSAI value for the Serving PLMN to V-SME by invoking Nsmf_PDUSession_UpdateSMContext service operation. The V-SMF updates NG RAN with the S-NSSAI value for the Serving PLMN via N2 SM message. If V-SMF relocation is needed, the AMF performs V-SMF relocation as defined in clause 4.23.4.3.
If the PDU Session(s) included in List Of PDU Sessions To Be Activated is not handled by the H-SMF, the SMF performs an SMF initiated SM Policy Association Modification procedure in step 14 if there is any policy trigger is met.
If there is PDU Session included in List Of PDU Sessions To Be Activated is handled by the H-SMF, the H-SMF performs SMF initiated SM Policy Association Modification procedure if there is any policy trigger is met when the V-SMF informs the H-SMF that the PDU Session UP has been activated.

In non-roaming and LBO cases and idle state mobility, AMF invokes Nsmf_PDUSession_CreateSMContext Request (UE EPS PDN Connection) service operation of the SMF+PGW-C and indicates all the PDU Session(s) to be re-activated as received in the Registration request message along with List Of PDU Sessions To Be Activated. This step is performed for each PDN Connection and the corresponding SMF+PGW-C address ID in the UE context the AMF received in Step 6.

The SMF+PGW-C finds the corresponding PDU Session based on the PDN Connection Context in the request.

If the SMF+P-GW-C(H-SMF in the case of home-routed roaming case) determines that seamless session continuity from EPS to 5GS is not supported for the PDU Session, (e.g. if PDU Session ID was not received by the SMF+PGW-C for the PDN connection or PDU Session ID) was received but mapped 5GS parameters were not provided to the UE due to 5GS interworking not supported), then it does not provide SM information for the corresponding PDU Session but includes the appropriate cause code for rejecting the PDU Session transfer within the N2 SM Information. The PDN connection(s) not further transferred to 5GC are locally released at the SMF+PGW-C.

Otherwise, if session continuity from EPS to 5GS is supported for the PDU Session, the SMF+PGW-C finds the corresponding PDU Session based on the PDN Connection Context in the request. The SMF+PGW-C initiates N4 Session modification procedure to establish the CN tunnel for the PDU Session, and for Idle state mobility registration, releases the resource of the CN tunnels for EPS bearers corresponding to the PDU session as well. If the SMF+PGW-C has not yet registered for this PDU Session ID, the SMF+PGW-C registers with the UDM using Nudm_UECM_Registration (SUPI, DNN, PDU Session ID)) for a given PDU Session as in step 4 of PDU Session Establishment Procedure in clause 4.3.2. The tunnel info for PDU Session is allocated by PGW-U. UPF and provided to the SMF+PGW-C. The SMF+PGW-C updates its SM contexts and returns the AMF a Nsmf_PDUSession_CreateSMContext Response message including the PDU Session ID corresponding to the PDN Connection Context in the request, the allocated EBI(s) information, the S-NSSAI of the PDU Session, and the N2 SM Context if the corresponding PDU Session is in the received List Of PDU Sessions To Be Activated. The AMF stores an association of the PDU Session ID and the SMF ID, S-NSSAI, and the allocated EBI(s) associated to the PDU Session ID. Based on the allocated EBI(s) information received from all the related SMF+PGW-C for this UE, an EPS bearer status, which reflects all existing EPS bearer, is generated by the AMI.

NOTE 3: For Connected State mobility registration, the release of CN tunnels for EPS bearers and UDM registration for the session corresponding to the PDU session is performed in the handover execution phase.

If the PDN Type of a PDN Connection in EPS is non-IP, and it was originally established as Ethernet PDU Session when UE was camping in 5GS (known based on local context information that was set to PDU Session Type Ethernet in UE and SME), the PDU Session Type in 5GS shall be set to Ethernet by the SMF and UE. If the PDN type of a PDN Connection in EPS is non-IP, and is locally associated in UE and SMF to PDU Session Type Unstructured, the PDU Session Type in 5GS shall be set to Unstructured by the SMF and UE.

NOTE 4: If the non-IP PDN Type is originally established as Ethernet PDU Session, it means that Ethernet PDN Type is not supported in EPS.

If the AMF has received the EPS Bearer Status in the Registration Request from UE, the AMF shall send the EPS Bearer Status to all corresponding SMF PGW-C's. If the SMF PGW-C receives the EPS Bearer Status from AMF, the SMF PGW-C shall check whether the EPS bearer(s) has been deleted by UE but not notified to network. If yes, the SMF PGW-C shall release those EPS bearer(s), the corresponding 5G QoS Rule(s) and the QoS Flow level QoS parameters locally.

If the SCEF+NEF ID is provided to the SME, the SMF establishes the SMF-NEF connection as described in steps 2-3 from clause 4.25.2, the SMF provides the SCEF+NEF ID, EBI, APN, User Identity to the SCEF NEF, and the SCEF+NEF updates the SM contexts and returns the NEF ID, PDU Session ID, DNN and User Identity to the SMF.

If the UE is performing Inter-RAT mobility to or from NB-IoT, the (H-)SMF will maintain, reconnect, release or leave PDU Session handling to the local VPLMN policy in the case of roaming for each PDU session according to the “PDU Session continuity at inter RAT mobility” subscription information. If the (H-)SMF does not have “PDU Session continuity at inter RAT mobility” for a PDU session, the (H-)SMF retrieves it from the UDM before determining any action. The SMF may use local policy to determine the handling a PDU Session if “PDU Session continuity at inter RAT mobility” cannot be retrieved from the UDM.

The other steps of FIG. 2b have been described in clause 4.11.1.3.3 of 3GPP TS 23.502 V17.0.0.

Embodiments herein may provide many advantages, of which a non-exhaustive list of examples follows. In some embodiments herein, the race condition is solved between A-SMF (anchor SMF) and I-SMF during inter/intra AMF idle mode mobility with UP connection activation during I-SMF insertion or change or during a procedure of UE triggered service request without I-SMF change or removal or during a procedure of UE triggered service request with intermediate SMF (I-SMF) insertion or change, which will make the procedure less complex and more reliable. In some embodiments herein, SMF could keep the action aligned between UE triggered service request procedure with I-SMF insertion or change and UE triggered service request procedure without I-SMF insertion or change. In some embodiments herein, the statement of “Step 16, the SMF gets the UE location information from I-SMF at step 5a. If dynamic PCC is deployed, the SMF may notify the UE location information to PCF and gets the updated policy” in clause 4.23.4.2 of 3GPP TS 23.502 V17.0.0 could be achieved and implemented. In some embodiments herein, the race condition is solved between A-SMF (H-SMF) and I-SMF (V-SMF) during EPS to 5GS Idle mobility using N26 interface with List of one or more PDU sessions To Be Activated. The embodiments herein are not limited to the features and advantages mentioned above. A person skilled in the art will recognize additional features and advantages upon reading the following detailed description.

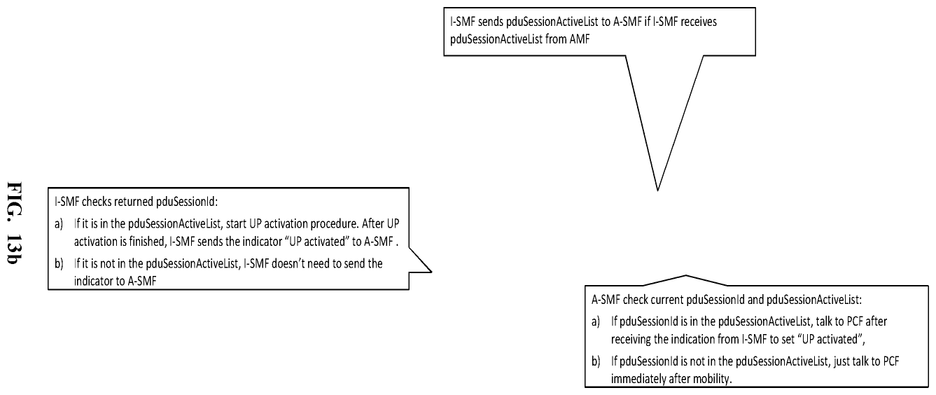

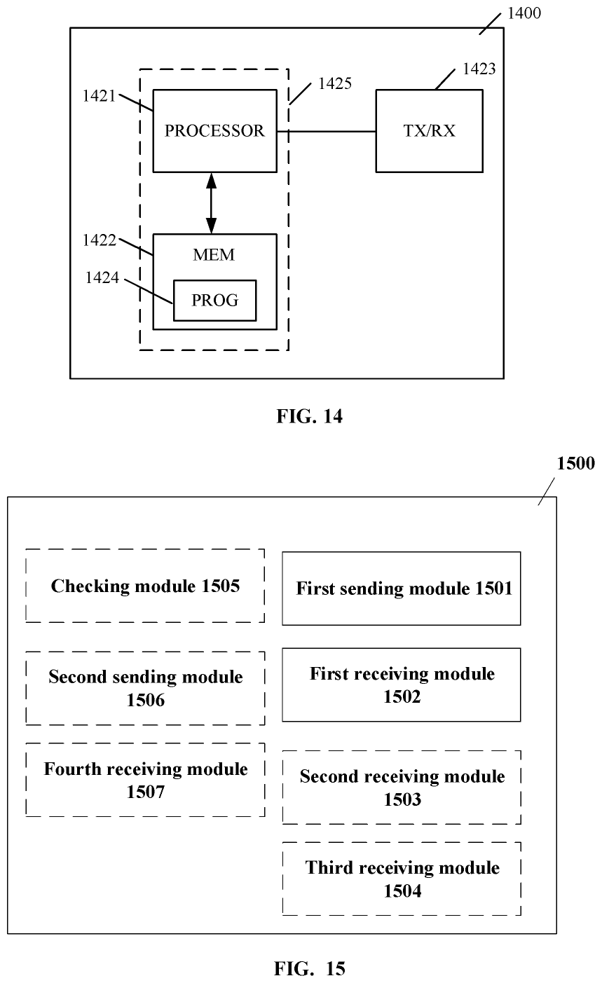

FIG. 14 is a block diagram showing an apparatus suitable for practicing some embodiments of the disclosure. For example, any one of the first SMF or the second SMF described above may be implemented as or through the apparatus 1400.

The apparatus 1400 comprises at least one processor 1421, such as a digital processor (DP), and at least one memory (MEM) 1422 coupled to the processor 1421. The apparatus 1400 may further comprise a transmitter TX and receiver RX 1423 coupled to the processor 1421. The MEM 1422 stores a program (PROG) 1424. The PROG 1424 may include instructions that, when executed on the associated processor 1421, enable the apparatus 1400 to operate in accordance with the embodiments of the present disclosure. A combination of the at least one processor 1421 and the at least one MEM 1422 may form processing means 1425 adapted to implement various embodiments of the present disclosure.

Various embodiments of the present disclosure may be implemented by computer program executable by one or more of the processor 1421, software, firmware, hardware or in a combination thereof.

The MEM 1422 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1421 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first SMF, the memory 1422 contains instructions executable by the processor 1421, whereby the first SMF operates according to any of the methods related to the first SMF as described above.

In an embodiment where the apparatus is implemented as or at the second SMF, the memory 1422 contains instructions executable by the processor 1421, whereby the second SMF operates according to any of the methods related to the second SMF as described above.

FIG. 15 is a block diagram showing a first session management function according to an embodiment of the disclosure. As shown, the first SMF 1500 comprises a first sending module 1501 configured to send to a second SMF a first request comprising a state of a user plane connection or an indication. The state or the indication indicates whether there is an ongoing procedure during which the first SMF is not able to handle update request from the second SMF. The first SMF 1500 further comprises a first receiving module 1502 configured to receive a first response from the second SMF.

In an embodiment, the first SMF 1500 further comprises a second receiving module 1503 configured to receive a second request for enforcing at least one updated policy or releasing a protocol data unit (PDU) session from the second SMF after receiving the first response from the second SMF, when the state of the user plane connection sent in the first request is ACTIVATED or DEACTIVATED or SUSPENDED or when the indication indicates there is not an ongoing procedure during which the first SMF is not able to handle update request from the second SMF.

In an embodiment, the first SMF further comprises a third receiving module 1504 configured to, when the state of the user plane connection sent in the first request is ACTIVATING or when the indication indicates there is an ongoing procedure during which the first SMF is not able to handle update request from the second SMF, receive a second request for enforcing at least one updated policy or releasing a protocol data unit (PDU) session from the second SMF after receiving the first response from the second SMF and when a timer of the second SMF expires.

In an embodiment, the first response comprises a PDU session identifier. The first SMF 1500 further comprises a checking module 1505 configured to check if the PDU session identifier is included in the list of one or more PDU sessions to be activated. The first SMF further comprises a second sending module 1506 configured to send information indicating that a PDU session corresponding to the PDU session identifier is activated to the second SMF when the PDU session identifier is included in the list of one or more PDU sessions to be activated and after the PDU session corresponding to the PDU session identifier is activated. The first SMF further comprises a fourth receiving module 1507 configured to receive a second request for enforcing at least one updated policy or releasing a PDU session from the second SMF.

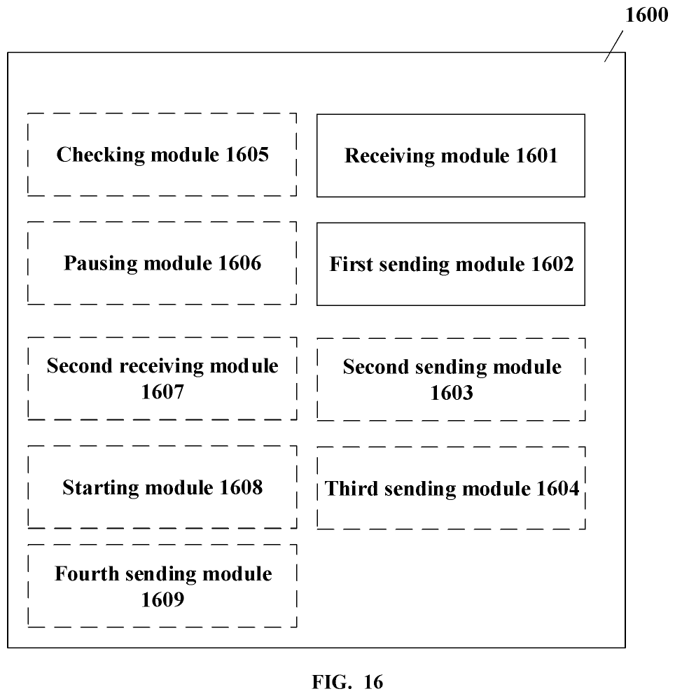

FIG. 16 is a block diagram showing a second session management function according to an embodiment of the disclosure. As shown, the second SMF 1600 comprises a receiving module 1601 configured to receive a first request comprising a state of a user plane connection or an indication from the first SMF. The state or the indication indicates whether there is an ongoing procedure during which the first SMF is not able to handle update request from the second SMF. The second SMF 1600 further comprises a first sending module 1602 configured to send a first response to the first SMF.

In an embodiment, the second SMF 1600 further comprises a second sending module 1603 configured to send a second request for enforcing at least one updated policy or releasing a protocol data unit (PDU) session to the first SMF after sending the first response to the first SMF when the state of the user plane connection received in the first request is ACTIVATED or DEACTIVATED or SUSPENDED or when the indication indicates there is not an ongoing procedure during which the first SMF is not able to handle update request from the second SMF.

In an embodiment, the second SMF 1600 further comprises a third sending module 1604 configured to send a second request for enforcing at least one updated policy or releasing a protocol data unit (PDU) session to the first SMF after sending the first response to the first SMF and when a timer of the second SMF expires, when the state of the user plane connection received in the first request is ACTIVATING or when the indication indicates there is an ongoing procedure during which the first SMF is not able to handle update request from the second SMF.

In an embodiment, the state of the user plane connection received in the first request comprises a list of one or more PDU sessions to be activated and the first response comprises a PDU session identifier. The second SMF 1600 further comprises a checking module 1605 configured to check if the PDU session identifier is included in the list of one or more PDU sessions to be activated. The second SMF further comprises a pausing module 1606 configured to, when the PDU session identifier is included in the list of one or more PDU sessions to be activated, pause sending a request for getting at least one updated policy to a policy control function. The second SMF further comprises a second receiving module 1607 configured to receive information indicating that a PDU session corresponding to the PDU session identifier is activated from the first SMF. The second SMF further comprises a starting module 1608 configured to, after receiving the information indicating that the PDU session corresponding to the PDU session identifier is activated from the first SMF, start to send the request for getting the at least one updated policy to the policy control function. The second SMF further comprises a fourth sending module 1609 configured to sending a second request for enforcing the at least one updated policy or releasing a PDU session to the first SMF.

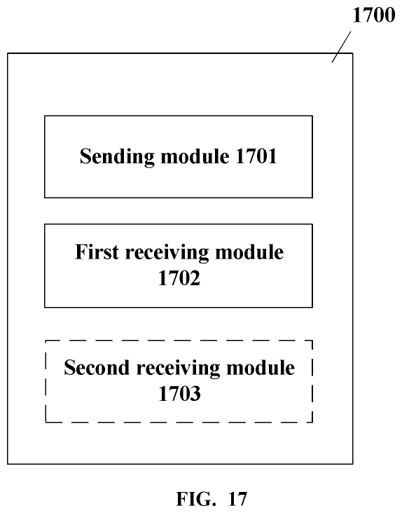

FIG. 17 is a block diagram showing a first session management function according to an embodiment of the disclosure. As shown, the first SMF 1700 comprises a sending module 1701 configured to send a third request to a second SMF based on a state of a user plane connection or whether there is an ongoing procedure during which the first SMF is not able to handle update request from the second SMF. The first SMF 1700 further comprises a first receiving module 1702 configured to receive a third response from the second SMF.

In an embodiment, the first SMF 1700 further comprises a second receiving module 1703 configured to receive a fourth request for enforcing at least one updated policy or releasing a protocol data unit (PDU) session from the second SMF after receiving the third response from the second SMF.

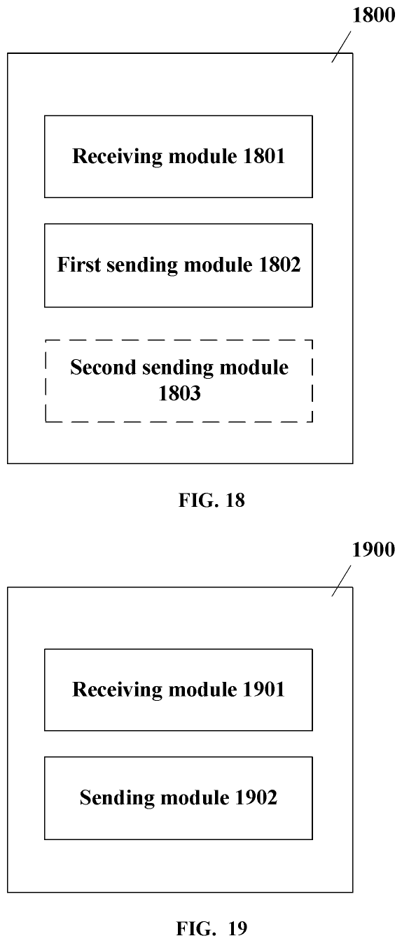

FIG. 18 is a block diagram showing a second session management function according to an embodiment of the disclosure. As shown, the second SMF 1800 comprises a receiving module 1801 configured to receive a third request from a first SMF. The third request is sent to the second SMF based on a state of a user plane connection or whether there is an ongoing procedure during which the first SMF is not able to handle update request from the second SMF. The second SMF 1800 further comprises a first sending module 1802 configured to send a third response to the first SMF.

In an embodiment, the second SMF 1800 further comprises a second sending module 1803 configured to send a fourth request for enforcing at least one updated policy or releasing a protocol data unit (PDU) session to the first SMF after sending the third response to the first SMF.

FIG. 19 is a block diagram showing a first session management function according to an embodiment of the disclosure. As shown, the first SMF 1900 comprises a receiving module 1901 configured to receive a request for enforcing at least one updated policy or releasing a protocol data unit (PDU) session from a second SMF. The first SMF 1900 further comprises a sending module 1902 configured to send a response comprising a response code set to 409 Conflict to the second SMF when a state of the user plane connection is ACTIVATING or when there is an ongoing procedure during which the first SMF is not able to handle update request from the second SMF.

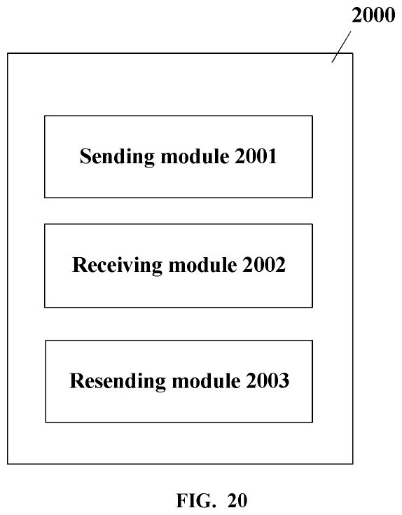

FIG. 20 is a block diagram showing a second session management function according to an embodiment of the disclosure. As shown, the second SMF 2000 comprises a sending module 2001 configured to send a request for enforcing at least one updated policy or releasing a protocol data unit (PDU) session to a first SMF. The second SMF 2000 further comprises a receiving module 2002 configured to receive a response comprising a response code set to 409 Conflict from the first SMF when a state of the user plane connection is ACTIVATING or when there is an ongoing procedure during which the first SMF is not able to handle update request from the second SMF. The second SMF 2000 further comprises a resending module 2003 configured to resend the request for enforcing at least one updated policy or releasing a protocol data unit (PDU) session to the first SMF after a time period.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first SMF or the second SMF may not need a fixed processor or memory, any computing resource and storage resource may be arranged from the first SMF or the second SMF in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a first session management function (SMF), comprising:
sending to a second SMF a first request comprising a state of a user plane connection or an indication, wherein the state or the indication indicates whether there is an ongoing procedure during which the first SMF is not able to handle update request from the second SMF; and
receiving a first response from the second SMF.

2. The method according to claim 1, wherein the state of the user plane connection comprises at least one of:
ACTIVATED,
DEACTIVATED,
ACTIVATING,
SUSPENDED, or
a list of protocol data unit (PDU) sessions to be activated.

3. The method according to claim 1, further comprising:
when the state of the user plane connection sent in the first request is ACTIVATED or DEACTIVATED or SUSPENDED or when the indication indicates there is not an ongoing procedure during which the first SMF is not able to handle update request from the second SMF, after receiving the first response from the second SMF, receiving a second request for enforcing at least one updated policy or releasing a protocol data unit (PDU) session from the second SMF; or
when the state of the user plane connection sent in the first request is ACTIVATING or when the indication indicates there is an ongoing procedure during which the first SMF is not able to handle update request from the second SMF, after receiving the first response from the second SMF and when a timer of the second SMF expires, receiving a second request for enforcing at least one updated policy or releasing a protocol data unit (PDU) session from the second SMF; or
when the first response comprises a PDU session identifier and the state of the user plane connection sent in the first request is the list of one or more PDU sessions to be activated, checking if the PDU session identifier is included in the list of one or more PDU sessions to be activated, sending information indicating that a PDU session corresponding to the PDU session identifier is activated to the second SMF when the PDU session identifier is included in the list of one or more PDU sessions to be activated and after the PDU session corresponding to the PDU session identifier is activated, and receiving a second request for enforcing at least one updated policy or releasing a PDU session from the second SMF.

4. The method according to claim 3, wherein the second request is a protocol data unit (PDU) session update request.

5. The method according to claim 3, wherein the second request comprises at least one updated policy or PDU session release information.

6. The method according to claim 1, wherein the first request is a PDU session update request and the first response is a PDU session update response.

7. The method according to claim 1, wherein the first request is a PDU session create request and the first response is a PDU session create response.

8. The method according to claim 1, wherein the first request further comprises information on policy control request trigger condition.

9. The method according to claim 8, wherein the information on policy control request trigger condition comprises at least one of:
user equipment (UE) location information,
a UE time zone, or
a serving network function identifier.

10. The method according to claim 1, wherein the first request is sent and the first response is received during
a procedure of UE triggered service request with intermediate SMF (I-SMF) insertion or change,
a procedure of UE triggered service request without I-SMF change or removal,
inter access and mobility function (AMF) idle mobility with user plane (UP) connection activation with intermediate SMF (I-SMF) insertion or change,
intra AMF idle mobility with UP connection activation with intermediate SMF (I-SMF) insertion or change, or
Evolved Packet System (EPS) to Fifth Generation System (5GS) Idle mode mobility using N26 interface.

11. The method according to claim 1, wherein
the first SMF is an I-SMF and the second SMF is an SMF,
the first SMF is a visited SMF and the second SMF is a home SMF, or
the first SMF is an I-SMF and the second SMF is a Packet Data Network Gateway control plane (PGW-C) combined with SMF.

12. A method performed by a second SMF, comprising:
receiving a first request comprising a state of a user plane connection or an indication from a first SMF, wherein the state or the indication indicates whether there is an ongoing procedure during which the first SMF is not able to handle update request from the second SMF; and
sending a first response to the first SMF.

13. The method according to claim 12, wherein the state of the user plane connection comprises at least one of:
ACTIVATED,
DEACTIVATED,
ACTIVATING, or
SUSPENDED, or
a list of protocol data unit (PDU) sessions to be activated.

14. The method according to claim 12, wherein when the state of the user plane connection received in the first request is ACTIVATED or DEACTIVATED or SUSPENDED or when the indication indicates there is not an ongoing procedure during which the first SMF is not able to handle update request from the second SMF, the method further comprises:
after sending the first response to the first SMF, sending a second request for enforcing at least one updated policy or releasing a protocol data unit (PDU) session to the first SMF.

15. The method according to claim 12, wherein when the state of the user plane connection received in the first request is ACTIVATING or when the indication indicates there is an ongoing procedure during which the first SMF is not able to handle update request from the second SMF, the method further comprises:
after sending the first response to the first SMF and when a timer of the second SMF expires, sending a second request for enforcing at least one updated policy or releasing a protocol data unit (PDU) session to the first SMF.

16. The method according to claim 12, wherein the state of the user plane connection received in the first request comprises a list of one or more PDU sessions to be activated and the first response comprises a PDU session identifier, the method further comprises:
checking if the PDU session identifier is included in the list of one or more PDU sessions to be activated;
when the PDU session identifier is included in the list of one or more PDU sessions to be activated, pausing sending a request for getting at least one updated policy to a policy control function;
receiving information indicating that a PDU session corresponding to the PDU session identifier is activated from the first SMF;
after receiving the information indicating that the PDU session corresponding to the PDU session identifier is activated from the first SMF, starting to send the request for getting the at least one updated policy to the policy control function; and
sending a second request for enforcing the at least one updated policy or releasing a PDU session to the first SMF.

17. The method according to claim 14, wherein the second request is a protocol data unit (PDU) session update request.

18.-20. (canceled)

21. The method according to claim 14, wherein the first request further comprises information on policy control request trigger condition.

22. The method according to claim 21, wherein the information on policy control request trigger condition comprises at least one of:
user equipment (UE) location information,
a UE time zone, or
a serving network function identifier.

23.-52. (canceled)

53. A first session management function (SMF), comprising:
a processor; and
a memory coupled to the processor, said memory containing instructions executable by said processor, whereby said first SMF is operative to:
send to a second SMF a first request comprising a state of a user plane connection or an indication, wherein the state or the indication indicates whether there is an ongoing procedure during which the first SMF is not able to handle update request from the second SMF; and
receive a first response from the second SMF.

54.-66. (canceled)
